(19) United States
(12) Patent Application Publication
(10) Pub. No.: US 2013/0242766 A1
(43) Pub. Date: Sep. 19, 2013

(54) PRE-SIB2 CHANNEL ESTIMATION AND SIGNAL PROCESSING IN THE PRESENCE OF MBSFN FOR LTE

(71) Applicants: Huilin XU, San Diego, CA (US); Raghu Narayan Challa, San Diego, CA (US); Rebecca Wen-Ling Yuan, San Diego, CA (US); Anant Hegde, San Diego, CA (US)

(72) Inventors: Huilin XU, San Diego, CA (US); Raghu Narayan Challa, San Diego, CA (US); Rebecca Wen-Ling Yuan, San Diego, CA (US); Anant Hegde, San Diego, CA (US)

(73) Assignee: QUALCOMM Incorporated, San Diego, CA (US)

(21) Appl. No.: 13/495,302

(22) Filed: Jun. 13, 2012

Related U.S. Application Data
(60) Provisional application No. 61/610,951, filed on Mar. 14, 2012.

(51) Int. Cl. H04W 4/06; H04J 1/00; H04J 3/00; H04W 24/00

(52) U.S. Cl. 370/252; 370/312; 370/281; 370/280

(57) ABSTRACT

A method, an apparatus, and a computer program product for wireless communication are provided. The apparatus updates a CIE in guaranteed non-MBSFN subframes. The apparatus refrains from updating at least one of an AGC, a TTL, an FTL, or an SNR estimation (FTL_SNR) in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

### CROSS-REFERENCE TO RELATED APPLICATION(S)

This application claims the benefit of U.S. Provisional Application Ser. No. 61/610,951, entitled “PRE-SIB2 CHANNEL ESTIMATION AND SIGNAL PROCESSING IN THE PRESENCE OF MBSFN FOR LTE” and filed on Mar. 14, 2012, which is expressly incorporated by reference herein in its entirety.

### BACKGROUND

1. Field

The present disclosure relates generally to communication systems, and more particularly, to channel estimation and signal processing before the system information block (SIB) 2 (SIB2) is decoded and in the presence of Multi-Media Broadcast over a Single Frequency Network (MBSFN) for Long Term Evolution (LTE).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus updates a channel and interference estimation in guaranteed non-MBSFN subframes. The apparatus refrains from updating at least one of an automatic gain control, a time tracking loop, a frequency tracking loop, or a signal to noise ratio estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating evolved Multicast Broadcast Multimedia Service in an MBSFN.

FIG. 8 is a diagram illustrating guaranteed non-MBSFN subframes and potential MBSFN subframes for both frequency division duplexing (FDD) and time division duplexing (TDD) systems.

FIG. 9 is a diagram illustrating an example of potential MBSFN subframes including both MBSFN subframes and non-MBSFN subframes.

FIG. 10 is a diagram illustrating a first exemplary method of performing channel estimation and signal processing.

FIG. 11 is a diagram illustrating a second exemplary method of performing channel estimation and signal processing.

FIG. 12 is a diagram illustrating a third exemplary method of performing channel estimation and signal processing.

FIG. 13 is a diagram illustrating a fourth exemplary method of performing channel estimation and signal processing.

FIG. 14 is a diagram illustrating a fifth exemplary method of performing channel estimation and signal processing.

FIG. 15 is a diagram illustrating a sixth exemplary method of performing channel estimation and signal processing.

FIG. 16 is a diagram illustrating a seventh exemplary method of performing channel estimation and signal processing.

FIG. 17 is a flow chart for first, second, third, fourth, fifth, sixth, and seventh exemplary methods of wireless communication.

FIG. 18 is a flow chart for the first exemplary method of wireless communication.

FIG. 19 is a flow chart for the second and the third exemplary methods of wireless communication.

FIG. 20 is a flow chart for the fourth exemplary method of wireless communication.

FIG. 21 is a flow chart for the fifth exemplary method of wireless communication.

FIG. 22 is a flow chart for the sixth exemplary method of wireless communication.

FIG. 23 is a flow chart for the seventh exemplary method of wireless communication.

FIG. 24 is a conceptual data flow diagram illustrating the data flow between different modules/means/components in an exemplary apparatus.

FIG. 25 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

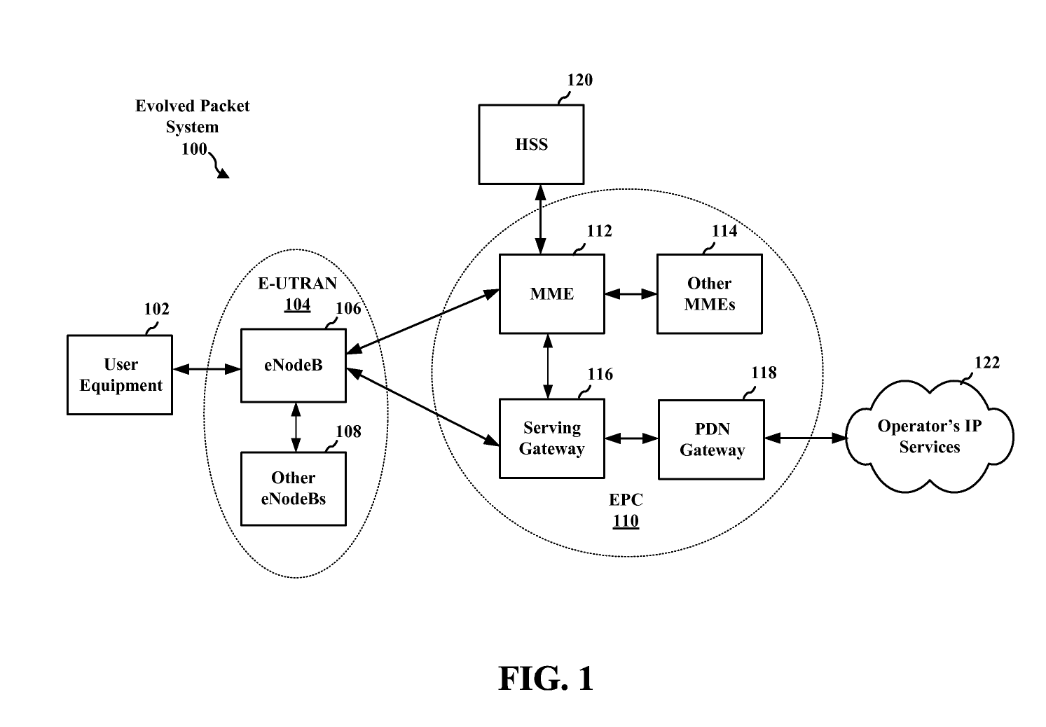

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an Si interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

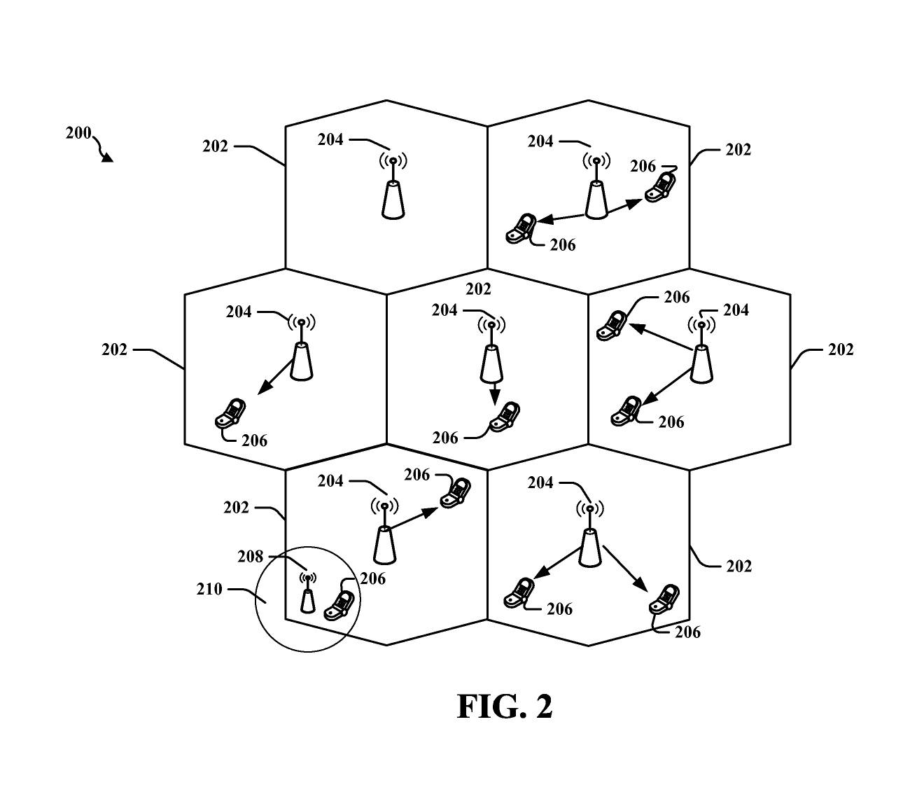

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both FDD and TDD. As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

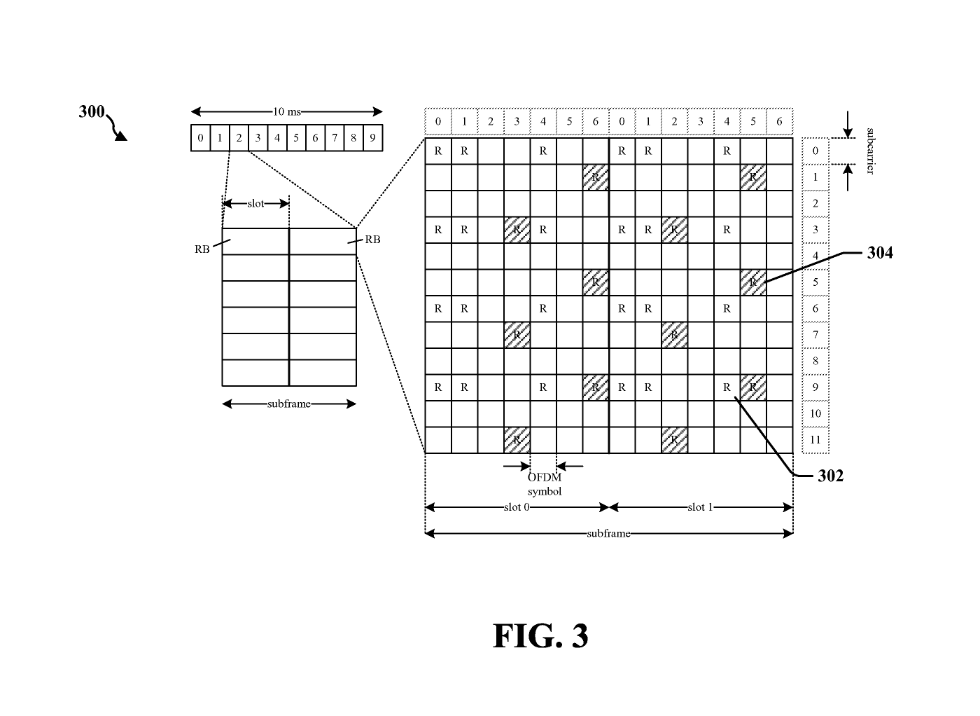

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

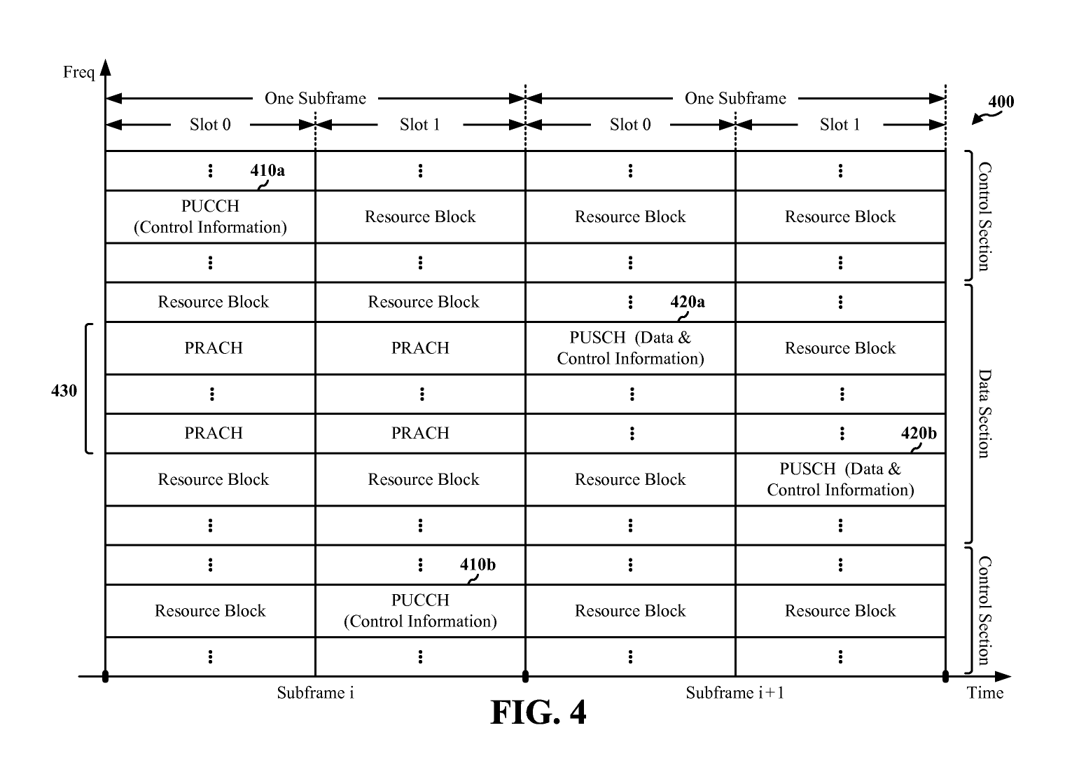

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

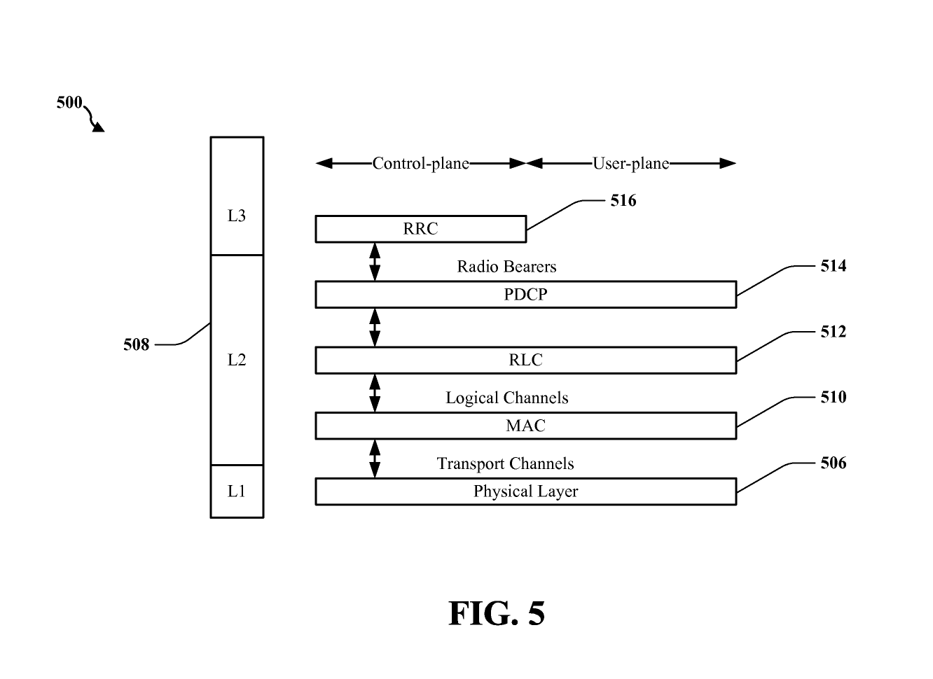

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

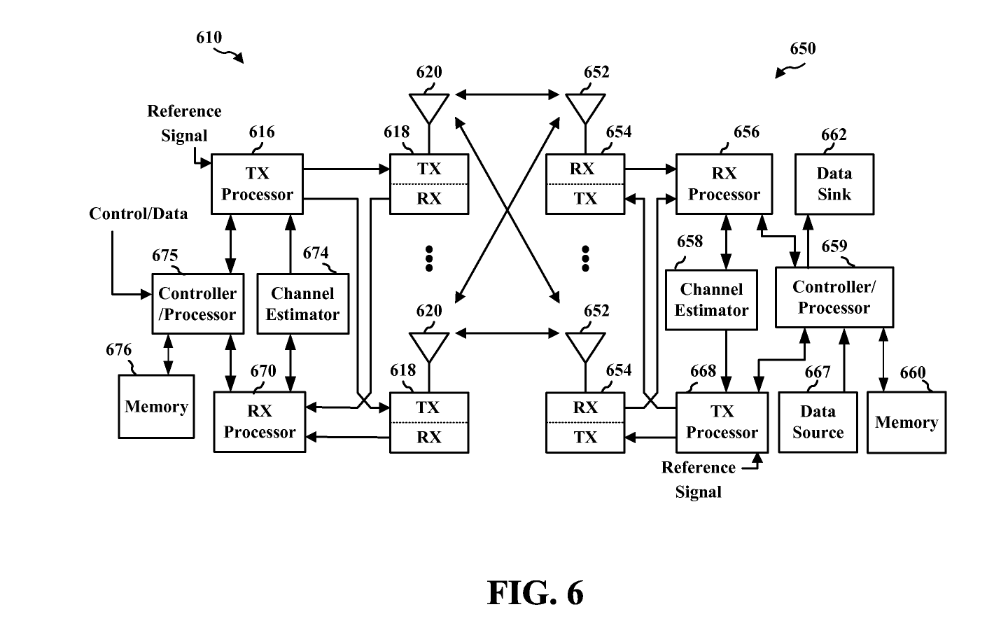

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

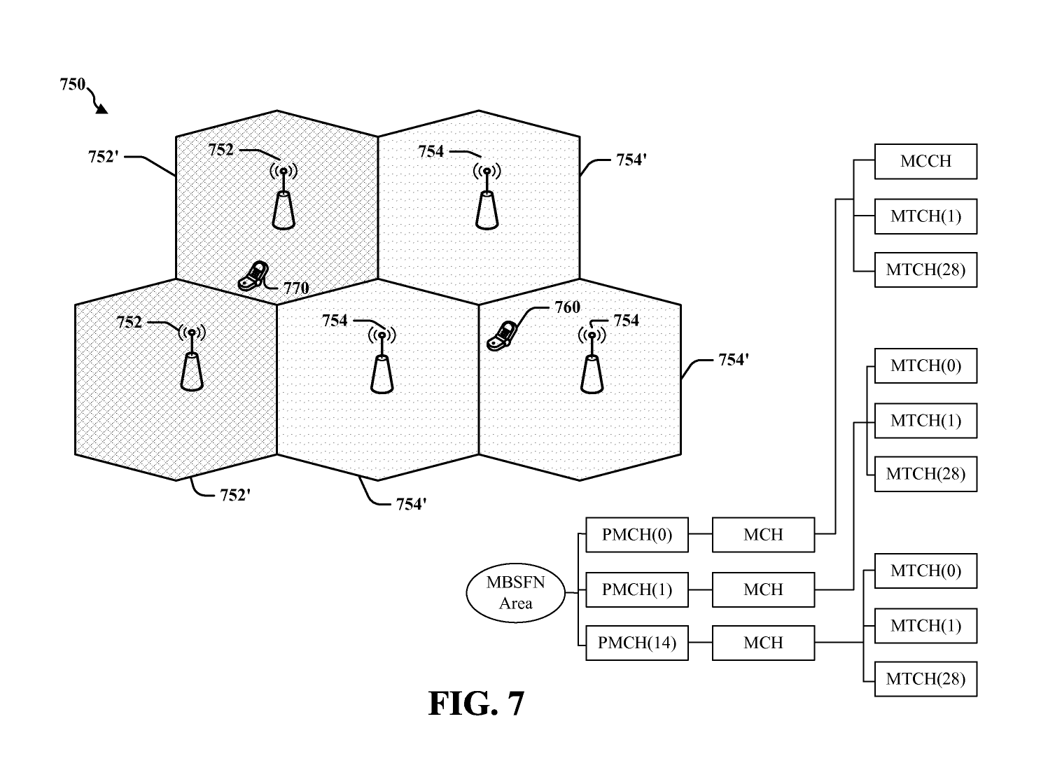

FIG. 7 is a diagram 750 illustrating evolved Multicast Broadcast Multimedia Service (eMBMS) in a Multi-Media Broadcast over a Single Frequency Network (MBSFN). The eNBs 752 in cells 752′ may form a first MBSFN area and the eNBs 754 in cells 754′ may form a second MBSFN area. The eNBs 752, 754 may be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

The SIBs are carried by dynamically scheduled system information messages within periodically occurring time domain windows within the PDSCH. The scheduling of system information message is specified in a schedulingInfoList in a SIB1. The SIB2 is in the system information message corresponding to the first entry of the schedulingInfoList. System information windows are consecutively placed according to the order of their corresponding entries in the schedulingInfoList. Within the system information window, the system information message can be transmitted a number of times in any subframe except subframe #5 (i.e., the sixth subframe) in radio frames in which the system frame number (SFN) modulo 2 equals 0, in subframes that have been assigned for MBSFN, and UL subframes in TDD (e.g., subframe 2). The physical downlink control channel (PDCCH) indicates in which subframes within the system information window the system information message is actually scheduled.

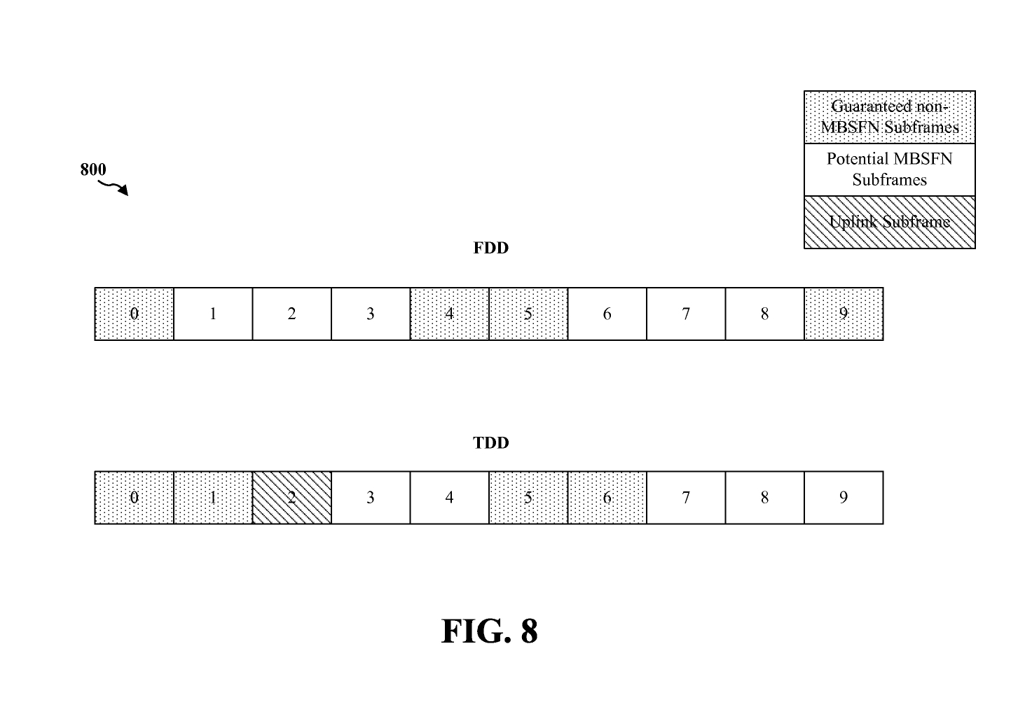

FIG. 8 is a diagram 800 illustrating guaranteed non-MBSFN subframes and potential MBSFN subframes for both FDD and TDD systems. The SIB2 carries information indicating which subframes within a radio frame are MBSFN subframes and non-MBSFN subframes. In other technologies, the information indicating which subframes within a radio frame are MBSFN subframes and non-MBSFN subframes may be conveyed through other system information or signals. Before a UE decodes the SIB2, the UE knows a set of subframes that are not MBSFN subframes and a set of subframes in which zero or more of those subframes may be MBSFN subframes. The set of subframes known to be non-MBSFN subframes is referred to herein as guaranteed non-MBSFN subframes. The set of subframes in which zero or more of those subframes may be MBSFN subframes is referred to herein as potential MBSFN subframes.

In an FDD system, the guaranteed non-MBSFN subframes are subframes 0, 4, 5, and 9, and the potential MBSFN subframes are 1, 2, 3, 6, 7, and 8. In a TDD system, the guaranteed non-MBSFN subframes are subframes 0, 1, 5, and 6, and the potential MBSFN subframes are 3, 4, 7, 8, and 9. In a TDD system, subframe 2 may always be an UL subframe, and therefore subframe 2 may not be a guaranteed non-MBSFN subframe or a potential MBSFN subframe.

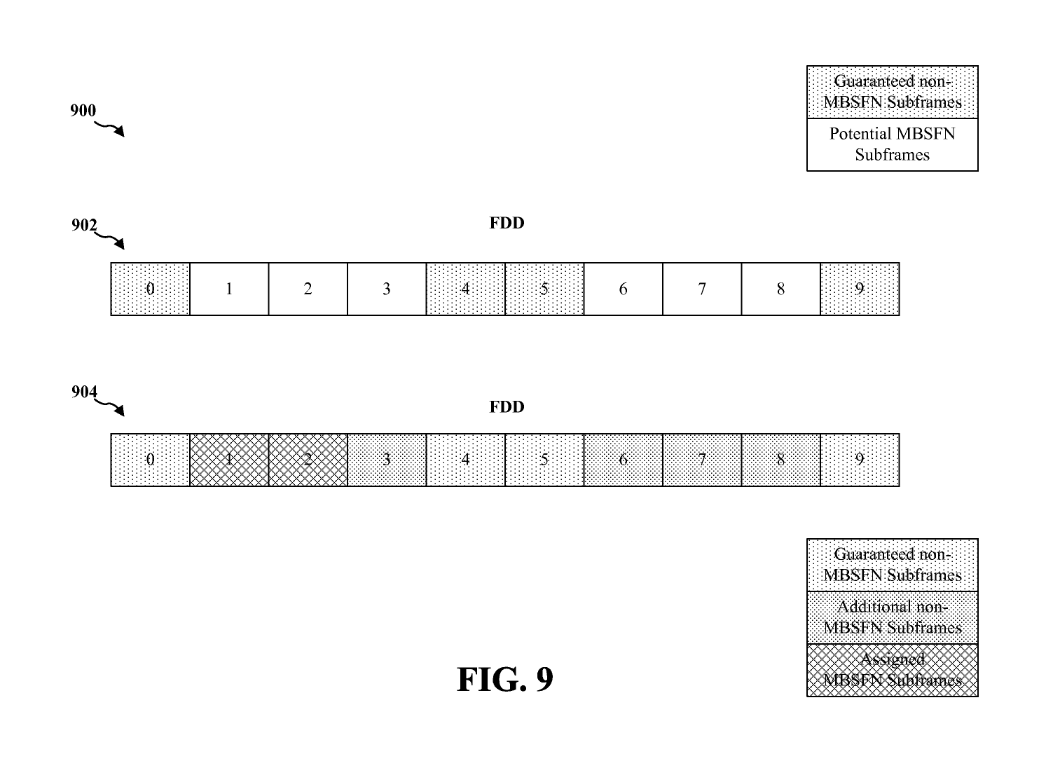

FIG. 9 is a diagram 900 illustrating an example of potential MBSFN subframes including both MBSFN subframes and non-MBSFN subframes. As shown in FIG. 9, for an FDD system, before a UE decodes the SIB2, the UE knows that within a radio frame 902, subframes 0, 4, 5, and 9 are guaranteed non-MBSFN subframes, and subframes 1, 2, 3, 6, 7, and 8 are potential MBSFN subframes. After the UE decodes the SIB2, the UE determines which subframes are assigned MBSFN subframes. For example, a SIB2 may specify that within a radio frame 904, subframes 1 and 2 are assigned MBSFN subframes and the remaining subframes are non-MBSFN subframes. The SIB2 can be scheduled in any non-MBSFN subframe, including any potential MBSFN subframe that is not actually an assigned MBSFN subframe.

A UE does not know the subframe in which the SIB2 may be received. In addition, before the SIB2 is decoded by a UE, the UE does not know which subframes are MBSFN subframes. There are several existing issues in relation to channel estimation and signal processing. First, a UE assumes there is no MBSFN until the SIB2 is decoded. As such, a UE assumes that all potential MBSFN subframes are non-MBSFN subframes, even though some of them may be MBSFN subframes. Second, a UE updates (i.e., determines a new value, filters the new value, and modifies a currently stored value based on the filtered new value) the channel and interference estimation (CIE), the time tracking loop (TTL), the frequency tracking loop (FTL), the signal to noise ratio (SNR) estimation, and the automatic gain control (AGC) based on DL unicast signals in order to build a unicast connection. Because a UE assumes that there is no MBSFN, the UE assumes that each of the DL subframes, including potential MBSFN subframes, carries a DL unicast signal. If some of the potential MSBFN subframes are MBSFN subframes, the CIE, TTL, FTL, SNR estimation, and AGC updates using such subframes may introduce errors due to the MBSFN signal. The SNR estimation is performed by correlating reference signals or pilots received from the same set of subcarriers. The FTL also uses this correlation operation. Therefore, SNR estimation may be referred to as FTL_SNR. Third, a UE assumes that a SIB2 may be received only in a guaranteed non-MBSFN subframe. However, a SIB2 may not necessarily be received only in a guaranteed non-MBSFN subframe. Accordingly, a UE may miss a SIB2 if the SIB2 comes in a potential MBSFN subframe. Further, if the CIE is not accurate due to updates based on MBSFN signals in MBSFN subframes, the UE may have difficulty decoding the SIB2 because all signal processing is based on the CIE. Accordingly, methods are needed for pre-SIB2 channel estimation and signal processing in the presence of MBSFN for LTE in order to enable improved channel estimation and signaling processing, including improved SIB2 decoding reliability.

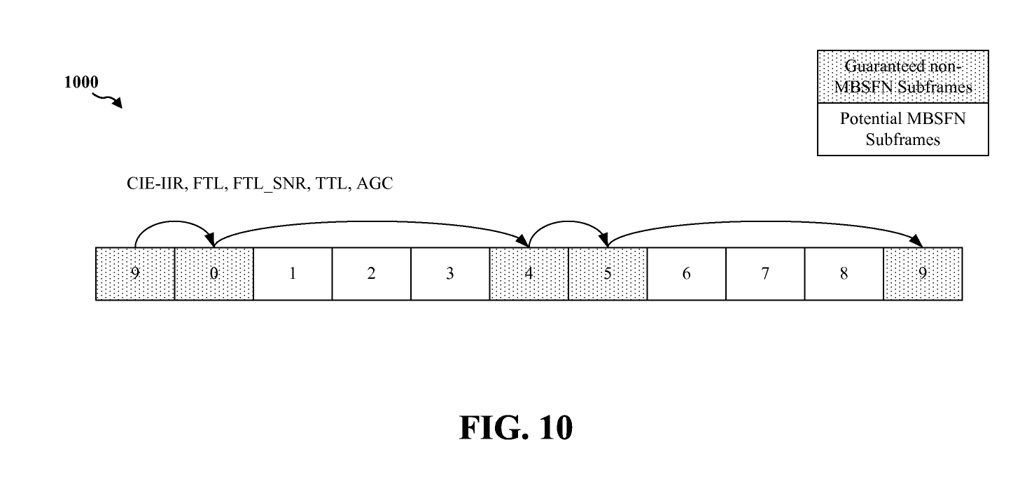

FIG. 10 is a diagram 1000 illustrating a first exemplary method of performing channel estimation and signal processing. In a first exemplary method, before the SIB2 is decoded, a UE updates the TTL, FTL, FTL_SNR, and AGC in guaranteed non-MBSFN subframes. In addition, the UE updates the CIE based on an infinite impulse response (IIR) filter in guaranteed non-MBSFN subframes. However, the UE refrains from updating the TTL, FTL, FTL_SNR, AGC, and the CIE in potential MBSFN subframes. As shown in FIG. 10 (for FDD), the CIE is updated based on an IIR filter, and the TTL, FTL, FTL_SNR, and the AGC are all updated in the guaranteed non-MBSFN subframes 0, 4, 5, and 9. The CIE, TTL, FTL, FTL_SNR, and AGC are not updated in the potential MBSFN subframes 1, 2, 3, 6, 7, and 8.

An advantage of the first exemplary method is that the method is not as complicated to implement as the other exemplary methods. A potential disadvantage of the first exemplary method is that the CIE can be stale for potential MBSFN subframes at high Doppler (i.e., UE mobility/velocity).

After the SIB2 is decoded, the UE determines which subframes are MBSFN subframes and non-MBSFN subframes. The UE then updates the CIE, TTL, FTL, FTL_SNR, and AGC based on the non-MBSFN subframes. After the SIB2 is decoded, the UE may update the CIE based on an IIR filter or a finite impulse response (FIR) filter.

The output of the IIR filter y(n) can be expressed as y(n)=(1−α)y(n−1)+αx(n), where n is the index of the reference signal OFDM symbol, x(n) is the input to the filter, and α is in [0,1]. Because the IIR filter is iterative (i.e., y(n) is a function of y(n−1)), if an MBSFN signal goes into the IIR filter, several iterations will be needed for the interference from the MBSFN signal to fade out. IIR filtering can be applied in the time domain for each tap of the channel impulse response (CIR) estimate or in the frequency domain per subcarrier estimate of the channel frequency response. The IIR input x(n) can refer to any CIR tap or frequency response on any subcarrier at the n^{th} reference signal OFDM symbol. The loop gain α can be adaptively chosen based on noise variance and Doppler effect of the channel. When the SNR and/or the Doppler frequency is lower, a smaller α may be used such that more averaging is applied. When the SNR and/or Doppler frequency is higher, a larger α may be used such that less average is applied, but the channel variation over time is better tracked/estimated.

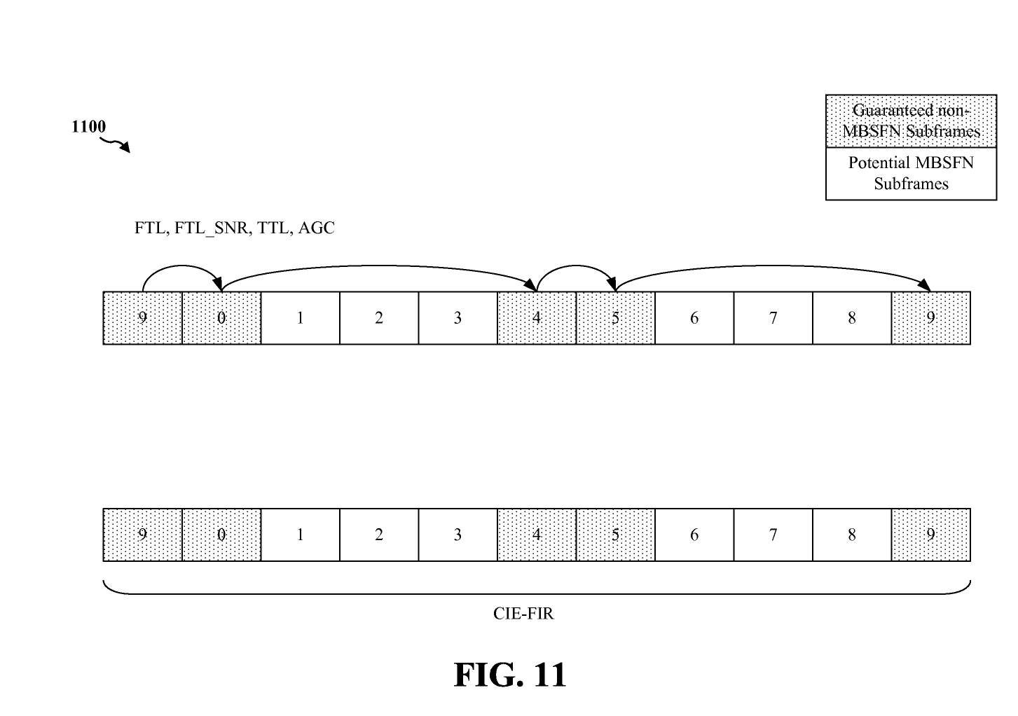

FIG. 11 is a diagram 1100 illustrating a second exemplary method of performing channel estimation and signal processing. In a second exemplary method, before the SIB2 is decoded, a UE updates the TTL, FTL, FTL_SNR, and AGC in guaranteed non-MBSFN subframes and refrains from updating the TTL, FTL, FTL_SNR, and AGC in potential MBSFN subframes. In addition, the UE updates the CIE based on a FIR filter in both the guaranteed non-MBSFN subframes and the potential MBSFN subframes. In the potential MBSFN subframes, the FIR filter is applied separately for each of the potential MBSFN subframes (i.e., the FIR filter is not applied to more than one potential MBSFN subframe at any one time), and therefore the FIR filter may be applied based on the reference signal OFDM symbols within one potential MBSFN subframe at a time. In the guaranteed non-MBSFN subframes, the FIR filter may be applied to more than one of those subframes at any one time, and therefore the FIR filter may be applied based on the reference signal OFDM symbols within more than one of the guaranteed non-MBSFN subframes at a time. As shown in FIG. 11 (for FDD), the TTL, FTL, FTL_SNR, and AGC are updated only in the guaranteed non-MBSFN subframes 0, 4, 5, and 9. In addition, the CIE is updated based on a FIR filter in both the guaranteed non-MBSFN subframes and potential MBSFN subframes.

An advantage of the second exemplary method is that the CIE is up-to-date in each subframe regardless of the UE mobility. A potential disadvantage of the second exemplary method is that no averaging is performed across the subframes due to the application of a FIR filter. When no or little averaging is performed, there may be more noise in the CIE estimate than when more averaging is performed.

After the SIB2 is decoded, the UE determines which subframes are MBSFN subframes and non-MBSFN subframes. The UE then updates the CIE, TTL, FTL, FTL_SNR, and AGC based on the non-MBSFN subframes. After the SIB2 is decoded, the UE may update the CIE based on an IIR filter or a FIR filter.

The output of the FIR filter y(n) can be expressed as y(n)=α_{-M}x(n−M)+α_{-M+1}x(n−M+1)+ . . . +α₀x(n)+ . . . +α_{N-1}x(n+N−1)+α_{N}x(n+N), where n is the index of the reference signal OFDM symbol, x(n) is the input to the filter, {α_{-M}, α_{-M+1}, α₀, . . . , α_{N-1}, α_{N}} are in [0,1], and M and N are selected such that the FIR filtering is limited inside one subframe of the potential MBSFN subframes (e.g., each subframe has four reference signal OFDM symbols for antenna ports 1 and 2 for a normal DL signal with normal cyclic-prefix (CP) (i.e., OFDM symbols 0 and 4 for slot 0 and OFDM symbols 0 and 4 for slot 1)) and no MBSFN multi-cast interference from an assigned MBSFN subframe goes into neighboring subframes. Because the FIR filter is not iterative (i.e., y(n) is not a function of y(n−1)), if an MBSFN signal goes into the FIR filter, interference from the MBSFN signal will not carry forward to subsequent updates. FIR filtering can be applied in the time domain for each tap of the CIR estimate over multiple reference signal OFDM symbols or in the frequency domain per subcarrier estimate of the channel frequency response over multiple reference signal OFDM symbols. The FIR input x(n) can refer to any CIR tap or frequency response on any subcarrier at the n^{th} reference signal OFDM symbol. The FIR channel estimation can be updated over any consecutive number of reference signal OFDM symbols as long as the updating is within a single potential MBSFN subframe.

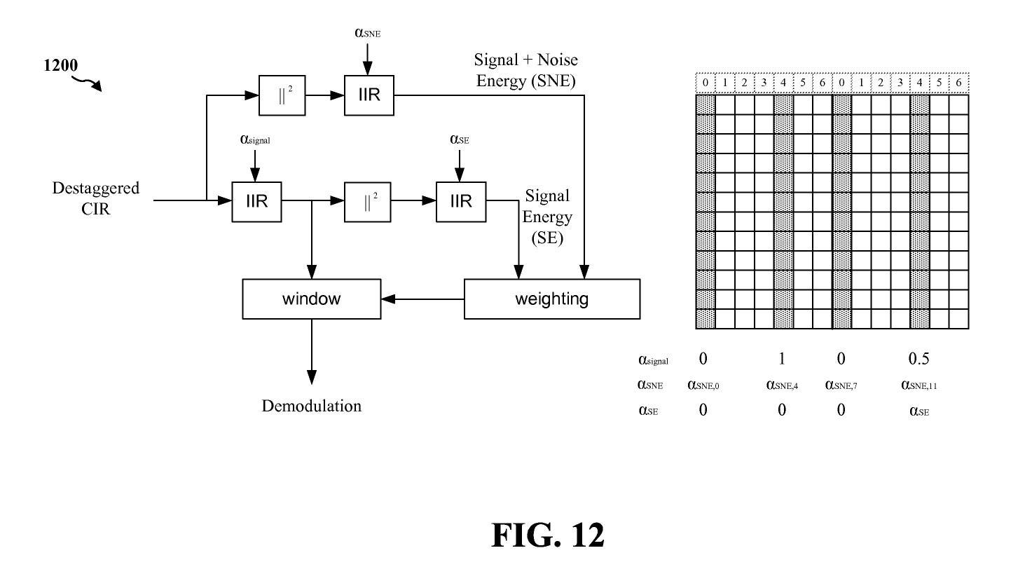

FIG. 12 is a diagram 1200 illustrating a third exemplary method of performing channel estimation and signal processing. The third exemplary method is similar to the second exemplary method, except that a weighting technique is applied. The elements of the CIE are coherent filtering for CIR, non-coherent filtering for both signal energy (SE) and signal plus noise energy (SNE), and per-tap minimum mean square error (MMSE) soft weighting for a windowing function. As shown in FIG. 12, the destaggered CIR is applied to an IIR filter. The FIR filtering result is the linear average of the four un-destaggered raw CIRs. If destaggering (i.e., the averaging of the adjacent two raw channel estimates) is enabled, the coefficients α_{signal} may be {0, 1, 0, 0.5} for the 1^{st} (OFDM symbol 0 of slot 0), 5^{th} (OFDM symbol 4 of slot 0), 8^{th} (OFDM symbol 0 of slot 1), and 12^{th} (OFDM symbol 4 of slot 1) OFDM symbols within a subframe. If destaggering is not enabled, the coefficients α_{signal} may be {1, ½, ⅓, ¼} for the 1^{st}, 5^{th}, 8^{th}, and 12^{th} OFDM symbols within a subframe. The coefficients cause the IIR filter to function as a FIR filter. The coherent filtered output is input into a window module, which applies windowing that is a function of SNE and SE. The SNE is determined by squaring the destaggered CIR and passing the result through an IIR filter with coefficients α_{SNE}. The SE is determined by passing the destaggered CIR through the IIR filter with coefficients α_{signal}, squaring the filtered destaggered CIR, and passing the result through an IIR filter with coefficients α_{SE}. The SNE and SE are determined only for guaranteed non-MBSFN subframes. However, the weighting window that is a function of the SNE and SE are used for each CIE update. The coefficients may be as shown in FIG. 12 for each of the 1^{st}, 5^{th}, 8^{th}, and 12^{th} reference signal OFDM symbols. The coefficient α_{SE} may not necessarily be zero in the first three reference signal OFDM symbols of a guaranteed non-MBSFN subframe. For any particular OFDM symbol, the coefficient α_{SE} may be related to the coefficients α_{SNE,n} for n=0, 4, 7, 11 by the equation α_{SE}=1−(1−α_{SNE,0})(1−α_{SNE,4})(1−α_{SNE,7})(1−α_{SNE,11}). The coefficients α_{SNE,n} may be derived from a coherent IIR coefficient table that is adaptive to SNR and UE mobility (same as normal IIR CIE). The coefficients α_{SNE,n} may equal the max{a′_{signal,n}/15,1/32}, where a′_{signal,n} is the coherent filtering coefficient for normal IIR CIE for symbol n in the subframe. The coefficient α_{SNE,0} may be equal to zero at the first reference signal OFDM symbol (e.g., the 1^{st} OFDM symbol) of subframes 4 and 9 for FDD to avoid MBSFN. A Doppler advance may be applied for α′_{signal,4} at the second reference signal OFDM symbol (e.g., the 5^{th} OFDM symbol) of subframes 4 and 9 for FDD. When channel Doppler frequency is larger than zero, the IIR filtering gain is increased in the guaranteed non-MBSFN subframes following MBSFN subframes (where the IIR filter output is frozen by setting the filtering gain to zero) such that stale information from previous guaranteed non-MBSFN subframes can fade out faster and fresh information in the current guaranteed non-MBSFN subframe is enhanced.

For the m^{th} channel tap, the MMSE soft weight is ω(m)=(SE(m)−αSNE(m))/((1−α)SE(m)). For FIR CIE, the equivalent coherent coefficient in calculating the optimal weights is α=0.5, which averages the two independent destaggered CIRs. If destaggering is not enabled, the equivalent coherent coefficient in calculating the weights is α=0.4. The weighting technique is applied for each CIR tap over multiple reference signal OFDM symbols. The same signal processing can be applied for each subcarrier over multiple reference signal OFDM symbols. The soft weights in the time domain may be combined with a brick-wall (rectangular) weighting window that zeroes out all taps outside the brick-wall weighting window which may be the length of the cyclic prefix. The center of the brick-wall may be adjusted according to the TTL output.

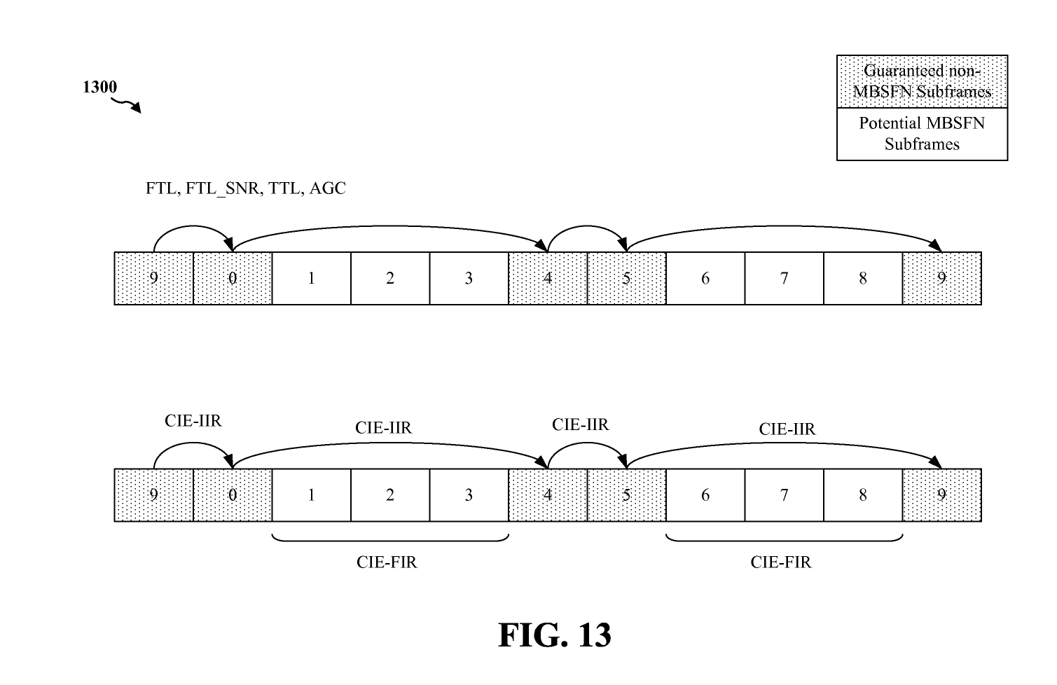

FIG. 13 is a diagram 1300 illustrating a fourth exemplary method of performing channel estimation and signal processing. In a fourth exemplary method, before the SIB2 is decoded, a UE updates the TTL, FTL, FTL_SNR, and AGC in guaranteed non-MBSFN subframes and refrains from updating the TTL, FTL, FTL_SNR, and AGC in potential MBSFN subframes. In addition, the UE updates the CIE based on an IIR filter in guaranteed non-MBSFN subframes and based on a FIR filter in potential MBSFN subframes. In the potential MBSFN subframes, the FIR filter is applied separately for each of the potential MBSFN subframes (i.e., the FIR filter may not be applied to more than one potential MBSFN subframe at any one time). As shown in FIG. 13 (for FDD), the TTL, FTL, FTL_SNR, and AGC are updated only in the guaranteed non-MBSFN subframes 0, 4, 5, and 9. In addition, the CIE is updated based on an IIR filter in the guaranteed non-MBSFN subframes 0, 4, 5, and 9, with the initialization of the IIR filter being the previous CIE from a previous guaranteed non-MBSFN subframe. Further, the CIE is updated based on a FIR filter in the potential MBSFN subframes. The CIE update based on the FIR filter is per subframe, as the FIR filter may not be applied to more than one potential MBSFN subframe at any one time.

An advantage of the fourth exemplary method is that the CIE is up-to-date in the potential MBSFN subframes regardless of the UE mobility for the potential MBSFN subframes. In addition, the CIE for the guaranteed non-MBSFN subframes gets the benefit of averaging. A potential disadvantage of the fourth exemplary method is that a first CIE based on the FIR filter and a second CIE based on the IIR filter is run simultaneously.

After the SIB2 is decoded, the UE determines which subframes are MBSFN subframes and non-MBSFN subframes. The UE then updates the CIE, TTL, FTL, FTL_SNR, and AGC based on the non-MBSFN subframes. After the SIB2 is decoded, the UE may update the CIE based on an IIR filter or a FIR filter.

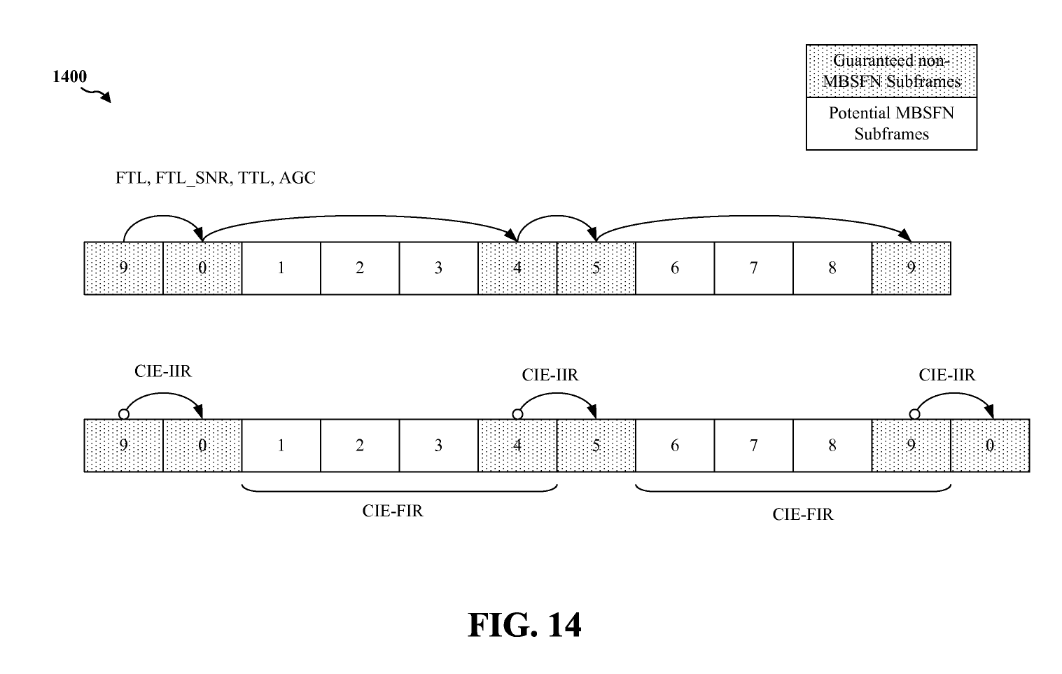

FIG. 14 is a diagram 1400 illustrating a fifth exemplary method of performing channel estimation and signal processing. In a fifth exemplary method, before the SIB2 is decoded, a UE updates the TTL, FTL, FTL_SNR, and AGC in guaranteed non-MBSFN subframes and refrains from updating the TTL, FTL, FTL_SNR, and AGC in potential MBSFN subframes. In addition, the UE updates the CIE based on an IIR filter in guaranteed non-MBSFN subframes following a first guaranteed non-MBSFN subframe subsequent to a potential MBSFN subframe. The UE updates the CIE based on a FIR filter in potential MBSFN subframes and a first guaranteed non-MBSFN subframe subsequent to a potential MBSFN subframe. In the potential MBSFN subframes and the first guaranteed non-MBSFN subframe subsequent to a potential MBSFN subframe, the FIR filter is applied separately for each of the subframes (i.e., the FIR filter may not be applied to more than one subframe at any one time). As shown in FIG. 14 (for FDD), the TTL, FTL, FTL_SNR, and AGC are updated only in the guaranteed non-MBSFN subframes 0, 4, 5, and 9. In addition, the CIE is updated based on an IIR filter in the guaranteed non-MBSFN subframes 0 and 5, and based on a FIR filter in the potential MBSFN subframes 1, 2, 3, 5, 6, 7, and in the guaranteed non-MBSFN subframes 4 and 9. The subframes 4 and 9 are both first guaranteed non-MBSFN subframes following a potential MBSFN subframe. As such, in these subframes the CIE is updated based on a FIR filter. In the guaranteed non-MBSFN subframes 5 and 0 that immediately follow the subframes 4 and 9, respectively, the CIE is updated based on an IIR filter.

An advantage of the fifth exemplary method is that for the potential MBSFN subframes, the CIE based on the FIR filter is up-to-date regardless of the UE mobility. In addition, the CIE based on the IIR filter gets the benefit of averaging over consecutive guaranteed non-MBSFN subframes. Further, there is fast convergence of the channel estimation by initializing the CIE based on the IIR filter with the result from the CIE based on the FIR filter in the first guaranteed non-MBSFN subframe following a potential MBSFN subframe. A potential disadvantage of the fifth exemplary method is that a first CIE based on the IIR filter and a second CIE based on the FIR filter is run simultaneously.

After the SIB2 is decoded, the UE determines which subframes are MBSFN subframes and non-MBSFN subframes. The UE then updates the CIE, TTL, FTL, FTL_SNR, and AGC based on the non-MBSFN subframes. After the SIB2 is decoded, the UE may update the CIE based on an IIR filter or a FIR filter.

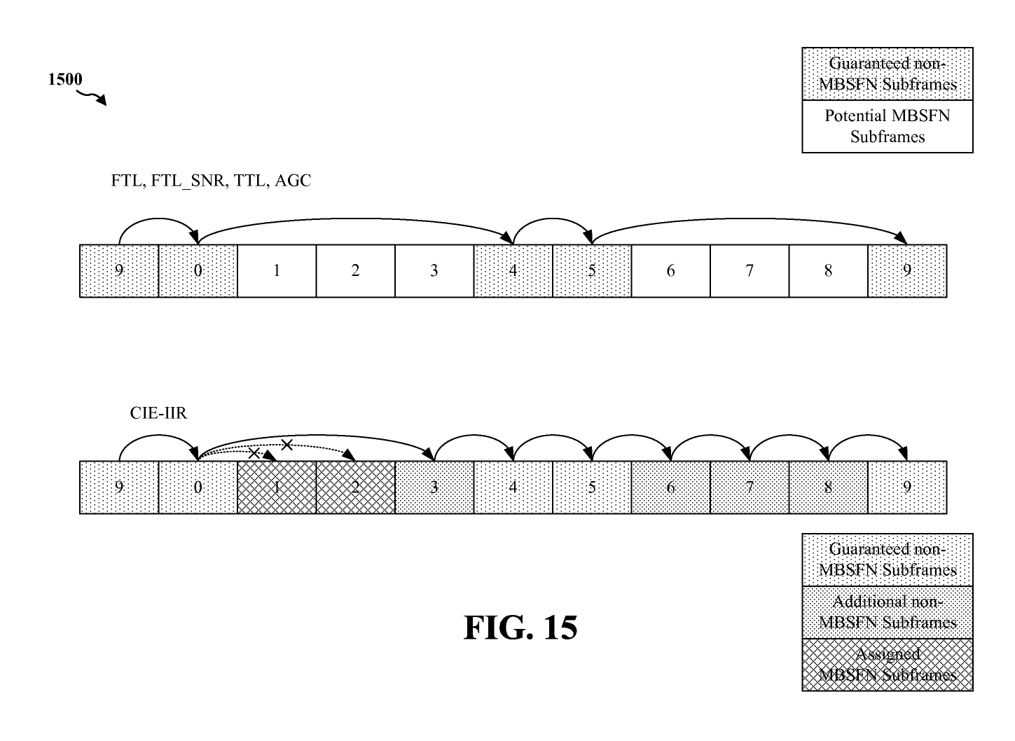

FIG. 15 is a diagram 1500 illustrating a sixth exemplary method of performing channel estimation and signal processing. In a sixth exemplary method, before the SIB2 is decoded, a UE updates the TTL, FTL, FTL_SNR, and AGC in guaranteed non-MBSFN subframes and refrains from updating the TTL, FTL, FTL_SNR, and AGC in potential MBSFN subframes. In addition, the UE updates the CIE based on an IIR filter in the guaranteed non-MBSFN subframes. The UE also updates the CIE based on the IIR filter in the potential MBSFN subframes if the FTL_SNR in the potential MBSFN subframes indicates that the subframe is not an MBSFN subframe. For potential MBSFN subframes, the UE determines the FTL_SNR, but does not update the FTL_SNR based on the determination. If the difference between the determined FTL_SNR and a previous FTL_SNR (i.e., previous FTL_SNR minus the determined FTL_SNR) is less than a threshold and/or the determined FTL_SNR is greater than a second threshold, the UE updates the CIE in that potential MBSFN subframe. However, if the difference between the determined FTL_SNR and a previous FTL_SNR is greater than the threshold and/or the determined FTL_SNR is less than a third threshold, the UE refrains from updating the CIE in that potential MBSFN subframe.

For example, as shown in FIG. 15 (for FDD), the TTL, FTL, FTL_SNR, and AGC are updated only in the guaranteed non-MBSFN subframes 0, 4, 5, and 9. With respect to the CIE, the CIE is updated based on an IIR filter in the guaranteed non-MBSFN subframe 0. In the potential MBSFN subframe 1 (which the UE does not know is an assigned MBSFN subframe), the UE determines the FTL_SNR and compares the determined FTL_SNR to the FTL_SNR determined in subframe 0. The UE determines that the difference between the FTL_SNRs in subframes 1 and 0 is greater than a threshold, and therefore the UE does not update the CIE in the potential MBSFN subframe 1. In the potential MBSFN subframe 2 (which the UE does not know is an assigned MBSFN subframe), the UE determines the FTL_SNR and compares the determined FTL_SNR to the FTL_SNR determined in subframe 0. The UE determines that the difference between the FTL_SNRs in subframes 2 and 0 is greater than a threshold, and therefore the UE does not update the CIE in the potential MBSFN subframe 2. In the potential MBSFN subframe 3 (which the UE does not know is a non-MBSFN subframe), the UE determines the FTL_SNR and compares the determined FTL_SNR to the FTL_SNR determined in subframe 0. The UE determines that the difference between the FTL_SNRs in subframes 3 and 0 is less than a threshold, and therefore the UE updates the CIE in the potential MBSFN subframe 3 based on the CIE from subframe 0.

An advantage of the sixth exemplary method is that the CIE may be optimal because the CIE is determined based on each non-MBSFN subframe. A potential disadvantage of the sixth exemplary method is that the method may not be reliable when the FTL_SNR determination is slow.

After the SIB2 is decoded, the UE determines which subframes are MBSFN subframes and non-MBSFN subframes. The UE then updates the CIE, TTL, FTL, FTL_SNR, and AGC based on the non-MBSFN subframes. After the SIB2 is decoded, the UE may update the CIE based on an IIR filter or a FIR filter.

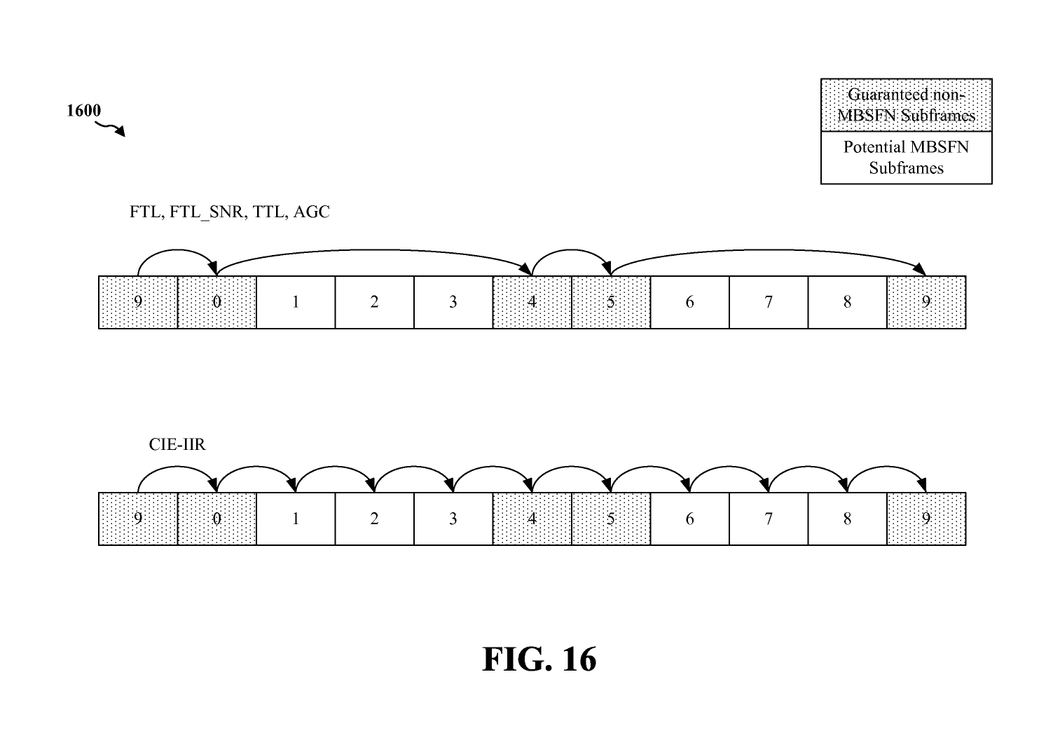

FIG. 16 is a diagram 1600 illustrating a seventh exemplary method of performing channel estimation and signal processing. In a seventh exemplary method, before the SIB2 is decoded, a UE updates the TTL, FTL, FTL_SNR, and AGC in guaranteed non-MBSFN subframes and refrains from updating the TTL, FTL, FTL_SNR, and AGC in potential MBSFN subframes. In addition, the UE updates the CIE based on an IIR filter in both the guaranteed non-MBSFN subframes and the potential MBSFN subframes. If the UE fails to decode the SIB2 within a period of time, the UE switches to one of the previous methods. For example, if the SIB2 is required to be transmitted at least once every 80 ms, the UE may set the period of time to be a*80 ms, where a is an integer equal to or greater than one. For example, if a=3, the UE will make three decoding attempts of the SIB2 before reverting to one of the other six exemplary methods upon failure to decode the SIB2.

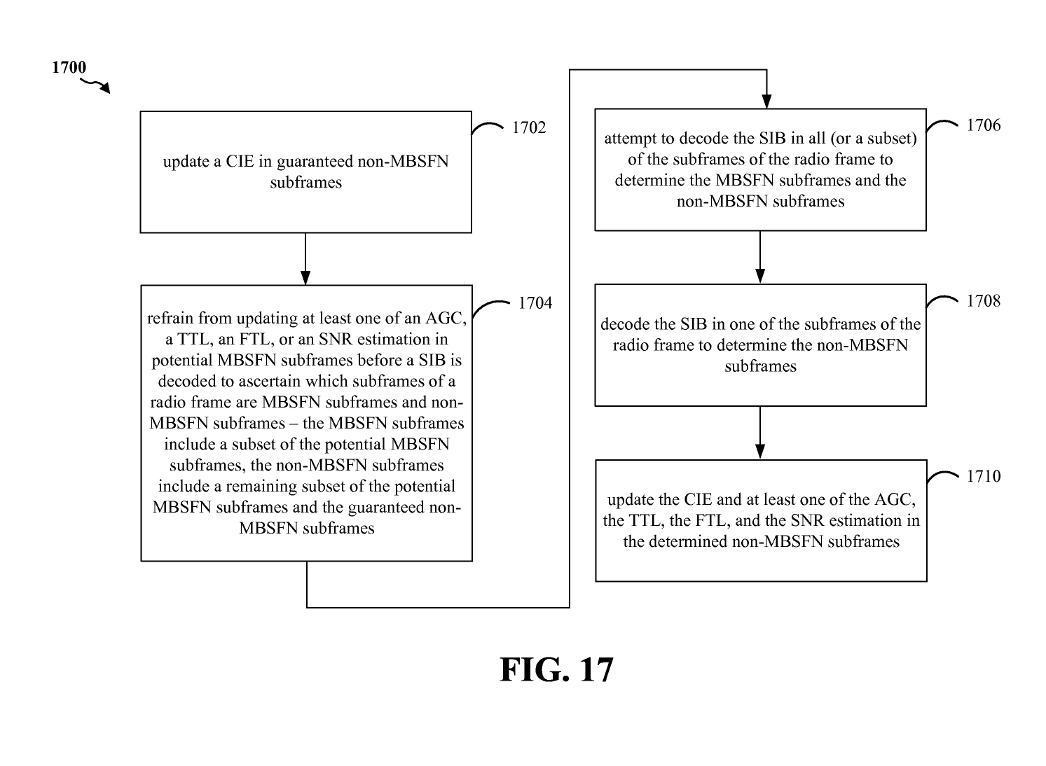

FIG. 17 is a flow chart 1700 for first, second, third, fourth, fifth, sixth, and seventh exemplary methods of wireless communication. The method may be performed by a UE. In step 1702, the UE updates a CIE in guaranteed non-MBSFN subframes. In step 1704, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

For example, for an FDD system, a UE may update the CIE in the guaranteed non-MBSFN subframes 0, 4, 5, and 9. In addition, the UE may refrain from updating the AGC, TTL, FTL, and FTL_SNR in the potential MBSFN subframes 1, 2, 3, 6, 7, and 8 before the SIB2 is decoded. Assume the UE eventually decodes the SIB2 and determines that subframes 1 and 2 are assigned MBSFN subframes and the remaining subframes are non-MBSFN subframes. In that case, the MBSFN subframes would include the subframes 1 and 2, which is a subset of the potential MBSFN subframes, and the non-MBSFN subframes would include the remaining subframes, which is a remaining subset of the potential MBSFN subframes and the guaranteed non-MBSFN subframes.

In step 1706, the UE may attempt to decode the SIB in a subset (e.g., all) of the subframes of the radio frame to determine the MBSFN subframes and the non-MBSFN subframes. If the decoding fails, the steps 1702 and 1704 are continued to be performed. Otherwise, if the decoding succeeds, steps 1708 and 1710 are performed. In step 1708, the UE may decode the SIB in one of the subframes of the radio frame to determine the non-MBSFN subframes. In step 1710, the UE may update the CIE and at least one of the AGC, the TTL, the FTL, and the SNR estimation in the determined non-MBSFN subframes.

In an FDD system, the guaranteed non-MBSFN subframes may include subframes 0, 4, 5, and 9 and the potential MBSFN subframes may include subframes 1, 2, 3, 6, 7, and 8. In a TDD system, the guaranteed non-MBSFN subframes may include subframes 0, 1, 5, and 6 and the potential MBSFN subframes may include subframes 3, 4, 7, 8, and 9. Different subframes may correspond to guaranteed non-MBSFN subframes and the potential MBSFN subframes for both FDD and TDD systems.

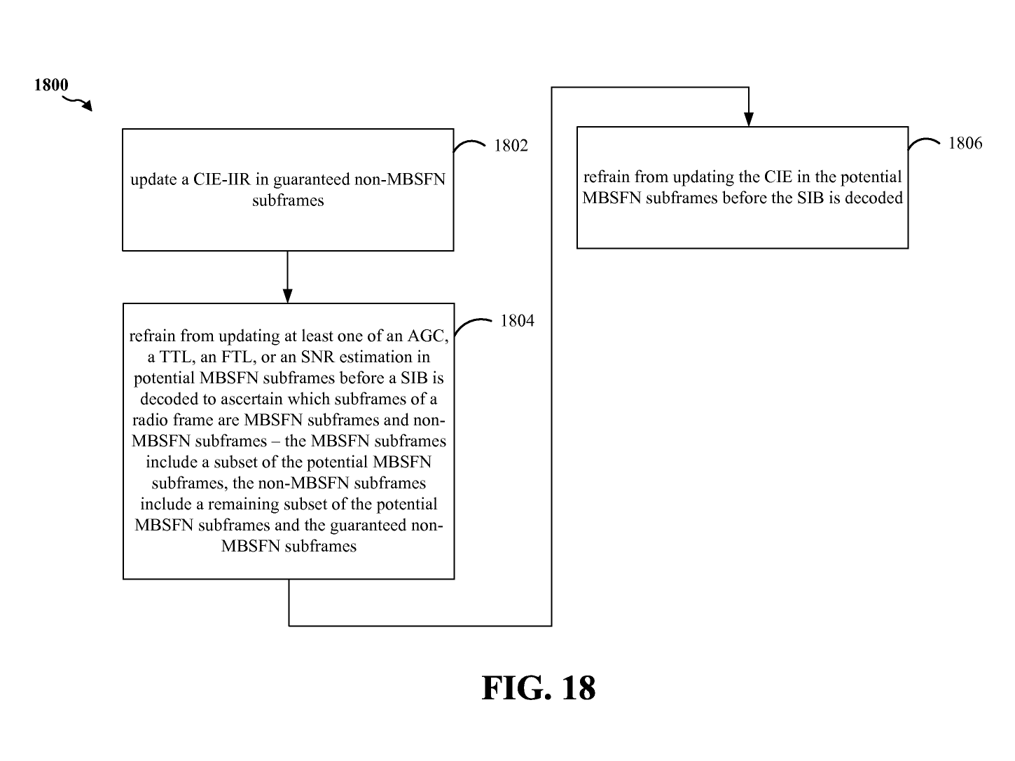

FIG. 18 is a flow chart 1800 for the first exemplary method of wireless communication. The method may be performed by a UE. In step 1802, the UE updates a CIE based on an IIR filter (herein referred to as CIE-IIR) in guaranteed non-MBSFN subframes. In step 1804, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes. In step 1806, the UE refrains from updating the CIE in the potential MBSFN subframes before the SIB is decoded.

For example, referring to FIG. 10, the UE updates a CIE, FTL, FTL_SNR, TTL, and AGC in the guaranteed non-MBSFN subframes 0, 4, 5, and 9. In addition, the UE refrains from updating the CIE, FTL, FTL_SNR, TTL, and AGC in the potential MBSFN subframes 1, 2, 3, 6, 7, and 8 before a SIB2 is decoded to ascertain which subframes of a radio frame are MBSFN subframes and non-MBSFN subframes.

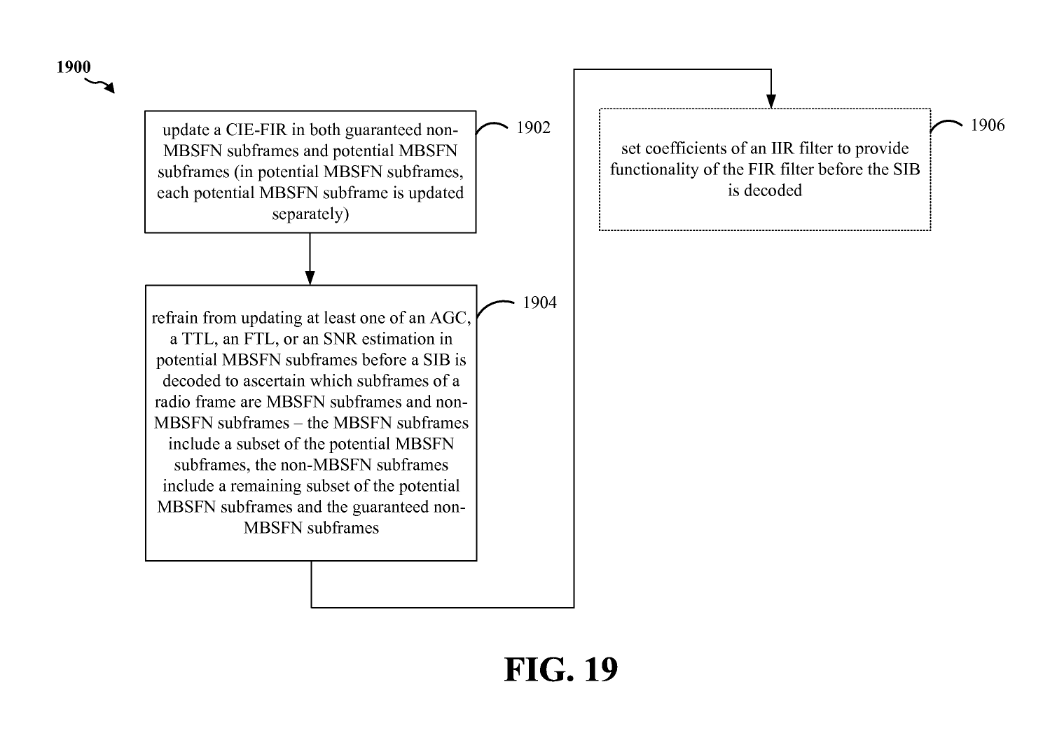

FIG. 19 is a flow chart 1900 for the second and the third exemplary methods of wireless communication. The method may be performed by a UE. In step 1902, the UE updates a CIE based on a FIR filter (herein referred to as CIE-IIR) in both guaranteed non-MBSFN subframes and potential MBSFN subframes. In step 1904, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

In the third exemplary method, the CIE-FIR may be updated further based on a weighting window. The weighting window may be a function of a CIR passed through the FIR filter, an SNE of the CIR, and an SE of the CIR. Further, in the third exemplary method, in step 1906, the UE may set coefficients of an IIR filter to provide functionality of the FIR filter before the SIB is decoded.

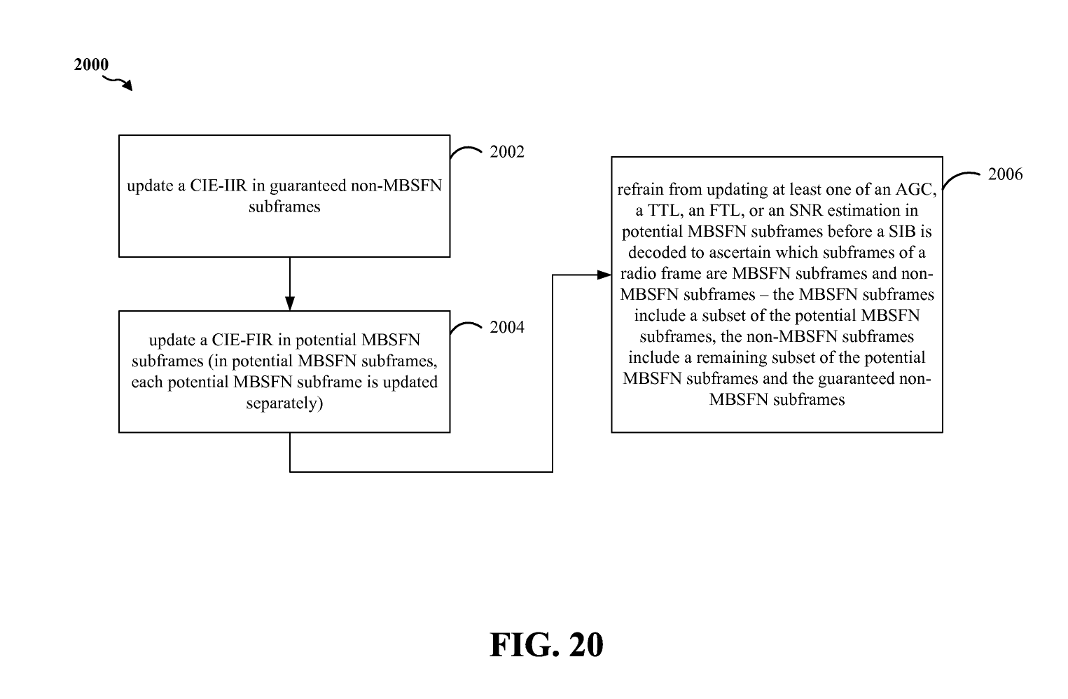

FIG. 20 is a flow chart 2000 for the fourth exemplary method of wireless communication. The method may be performed by a UE. In step 2002, the UE updates a CIE-IIR in guaranteed non-MBSFN subframes. In step 2004, the UE updates a CIE-FIR in potential MBSFN subframes. In step 2006, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

For example, referring to FIG. 13, before a SIB2 is decoded to ascertain which subframes of a radio frame are MBSFN subframes and non-MBSFN subframes, a UE updates the FTL, FTL_SNR, TTL, and AGC in the guaranteed non-MBSFN subframes 0, 4, 5, and 9, and refrains from updating the FTL, FTL_SNR, TTL, and AGC in the potential MBSFN subframes 1, 2, 3, 6, 7, and 8. Furthermore, the UE updates a CIE-IIR based on the guaranteed non-MBSFN subframes 0, 4, 5, and 9, and a CIE-FIR based on the potential MBSFN subframes 1, 2, 3, 6, 7, and 8.

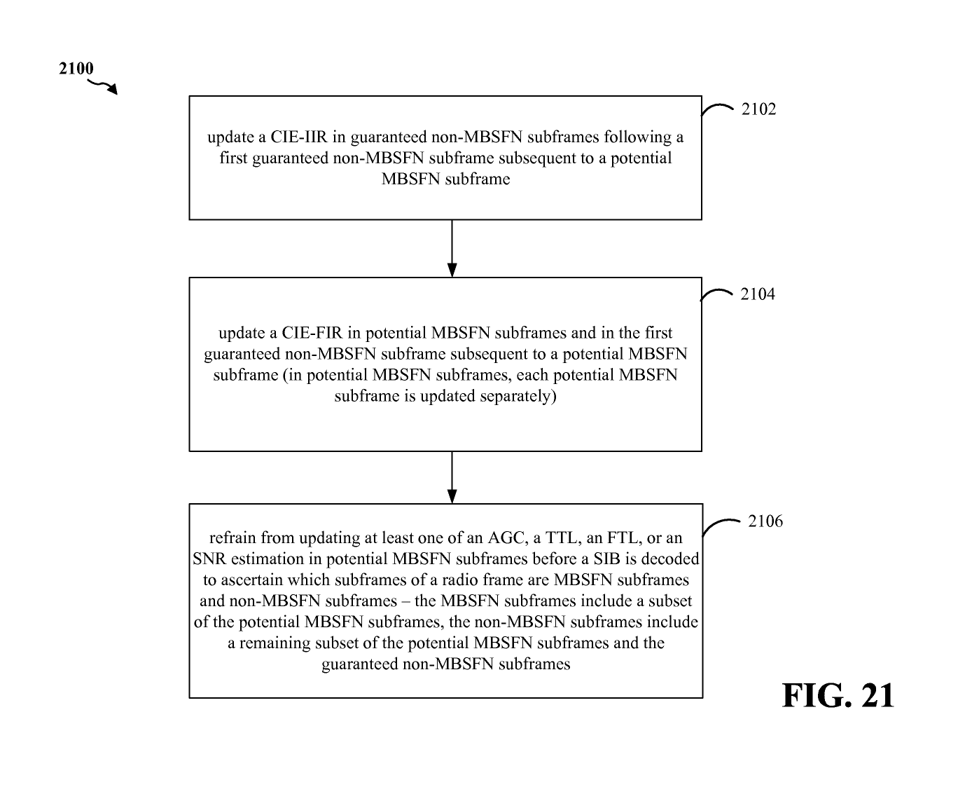

FIG. 21 is a flow chart 2100 for the fifth exemplary method of wireless communication. The method may be performed by a UE. In step 2102, the UE updates a CIE-IIR in guaranteed non-MBSFN subframes following a first guaranteed non-MBSFN subframe subsequent to a potential MBSFN subframe. In step 2104, the UE updates a CIE-FIR in potential MBSFN subframes and in the first guaranteed non-MBSFN subframe subsequent to a potential MBSFN subframe. In step 2106, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

The CIE-IIR for a guaranteed non-MBSFN subframe following a first guaranteed non-MBSFN subframe subsequent to a potential MBSFN subframe may be initialized with the CIE-FIR from the first guaranteed non-MBSFN subframe subsequent to the potential MBSFN subframe. That is, the CIE-IIR for a second consecutive guaranteed non-MBSFN subframe may be initialized with the CIE-FIR from the first consecutive guaranteed non-MBSFN subframe.

For example, referring to FIG. 14, before a SIB2 is decoded to ascertain which subframes of a radio frame are MBSFN subframes and non-MBSFN subframes, a UE updates the FTL, FTL_SNR, TTL, and AGC in the guaranteed non-MBSFN subframes 0, 4, 5, and 9, and refrains from updating the FTL, FTL_SNR, TTL, and AGC in the potential MBSFN subframes 1, 2, 3, 6, 7, and 8. In addition, the UE updates a CIE-IIR based on the guaranteed non-MBSFN subframes 0 and 5, and a CIE-FIR based on the potential MBSFN subframes 1, 2, 3, 6, 7, and 8 and on the guaranteed non-MBSFN subframes 4 and 9. The update of the CIE-IIR based on the guaranteed non-MBSFN subframe 0 may be initialized with the CIE-FIR determined in subframe 9, and the update of the CIE-IIR based on the guaranteed non-MBSFN subframe 5 may be initialized with the CIE-FIR determined in subframe 4.

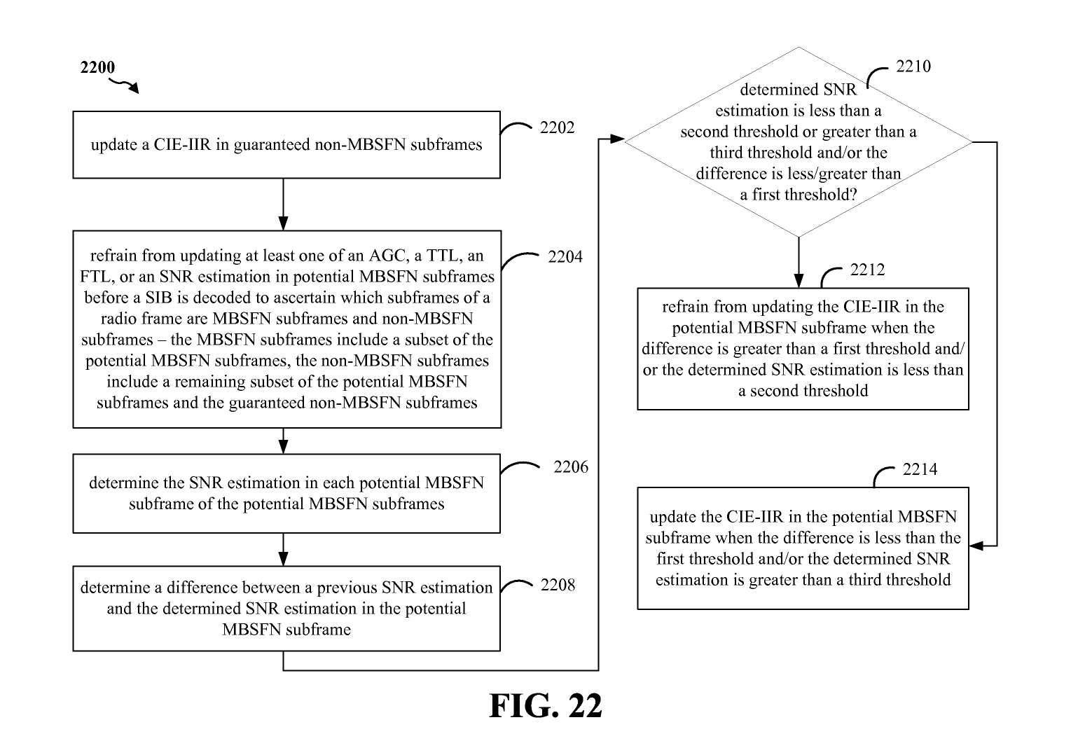

FIG. 22 is a flow chart 2200 for the sixth exemplary method of wireless communication. The method may be performed by a UE. In step 2202, the UE updates a CIE-IIR in guaranteed non-MBSFN subframes. In step 2204, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

In step 2206, the UE may determine the SNR estimation in each potential MBSFN subframe of the potential MBSFN subframes. In step 2208, the UE may determine a difference between a previous SNR estimation and the determined SNR estimation in the potential MBSFN subframe (i.e., the difference is the previous SNR estimation in dB minus the determined SNR estimation in dB). In step 2210, the UE determines whether the determined SNR estimation is less than a second threshold (e.g., 0 dB) or greater than a third threshold (e.g., 3 dB) and/or whether the difference is less/greater than a first threshold (e.g., 3 dB). The third threshold is greater than the second threshold. Based on the result, in step 2212, the UE refrains from updating the CIE in the potential MBSFN subframe when the difference is greater than a first threshold and/or the determined SNR estimation is less than a second threshold. In step 2214, the UE updates the CIE in the potential MBSFN subframe when the difference is less than the first threshold and/or the determined SNR estimation is greater than a third threshold.

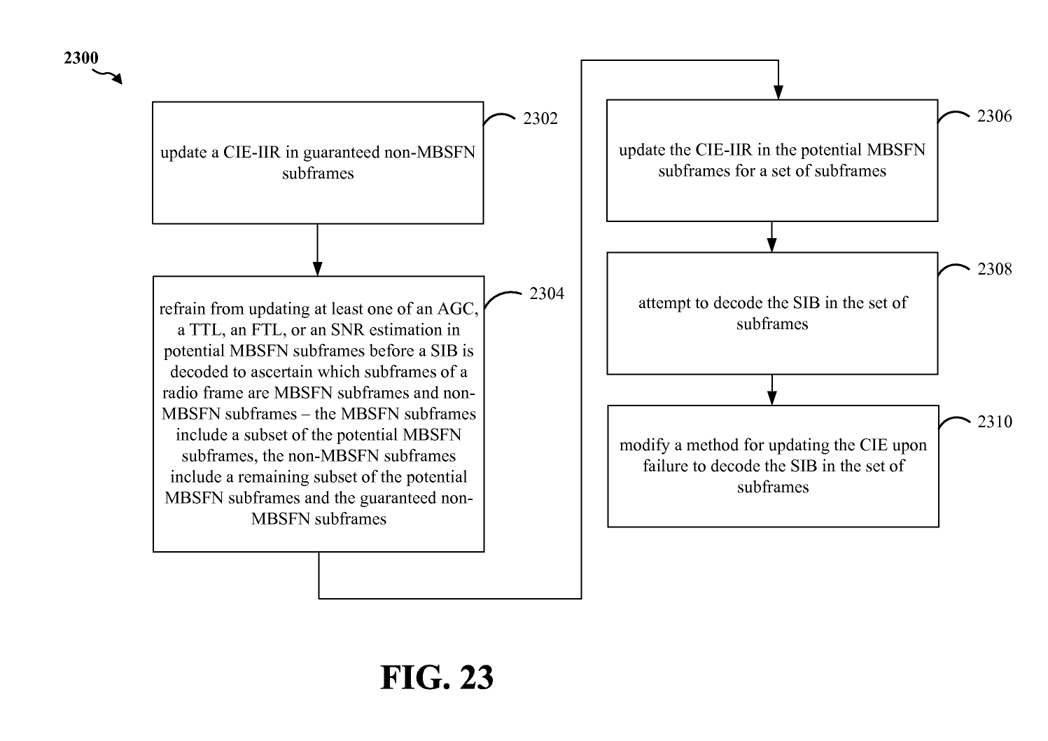

FIG. 23 is a flow chart 2300 for the seventh exemplary method of wireless communication. The method may be performed by a UE. In step 2302, the UE updates a CIE-IIR in guaranteed non-MBSFN subframes. In step 2304, the UE refrains from updating at least one of an AGC, a TTL, an FTL, or an SNR estimation in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

In step 2306, the UE may update the CIE-IIR in the potential MBSFN subframes for a set of subframes. In step 2308, the UE may attempt to decode the SIB in the set of subframes. If decoding of the SIB succeeds, the UE will determine the non-MBSFN subframes and update the CIE, FTL, TTL, FTL_SNR, and AGC based on the non-MBSFN subframes. Otherwise, if the decoding of the SIB fails, in step 2310, the UE may modify a method for updating the CIE upon failure to decode the SIB in the set of subframes by reverting to one of the first, second, third, fourth, fifth, sixth exemplary methods, or some other method that is a combination of one or more of these methods.

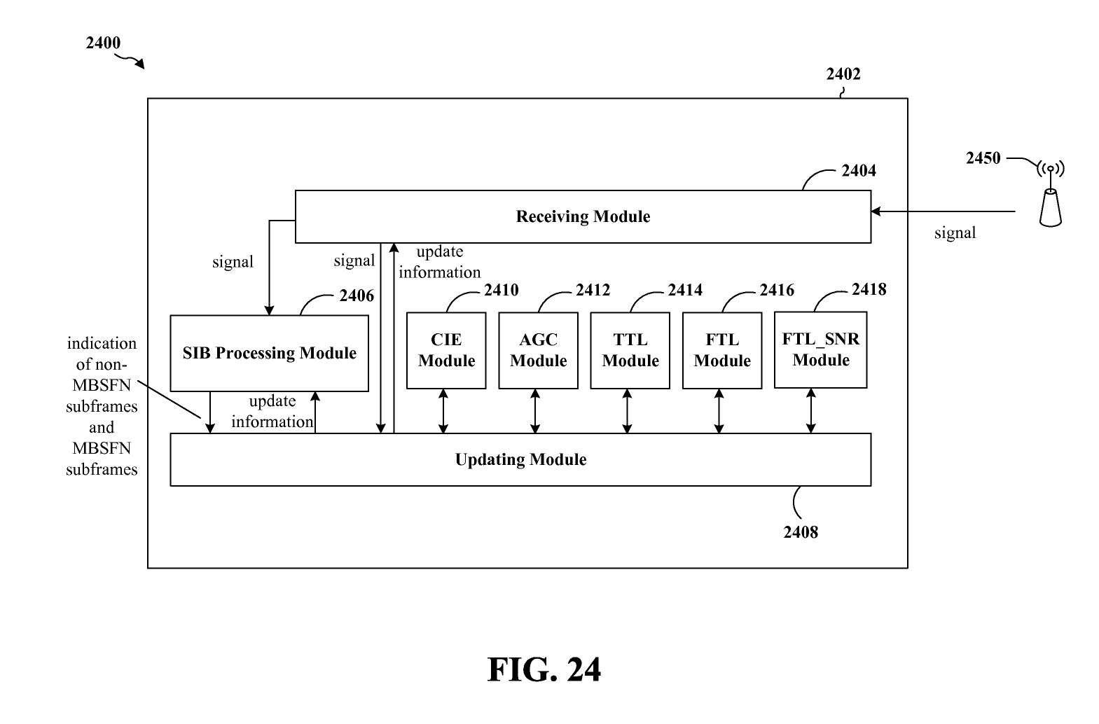

FIG. 24 is a conceptual data flow diagram 2400 illustrating the data flow between different modules/means/components in an exemplary apparatus 2402. The apparatus includes a receiving module 2404 that receives signals from the eNB 2450 in a plurality of OFDM symbols within subframes of a radio frame. The receiving module 2404 may receive update information from the updating module 2408 in order to properly receive signals from the eNB 2450. The update information includes amplifier gain information from the AGC, timing correction information from the TTL, frequency error correction information from the FTL, SNR information from the FTL_SNR, and channel and interference estimation information from the CIE. The receiving module 2404 provides the received signals to a SIB processing module 2406, which attempts to decode a SIB2. If the SIB processing module 2406 successfully decodes the SIB2, the SIB processing module 2406 provides information to the updating module 2408 indicating which subframes of a radio frame are MBSFN subframes and non-MBSFN subframes. The updating module 2408 controls how the CIE, AGC, TTL, FTL, and FTL_SNR are updated based on whether the SIB2 has been decoded. As such, the updating module 2408 communicates with the CIE module 2410, AGC module 2412, TTL module 2414, FTL module 2416, and FTL_SNR module 2418 to control whether and how the CIE, AGC, TTL, FTL, and FTL_SNR are updated in each of the subframes. The updating module 2408 provides the update information to the receiving module 2404 for allowing the receiving module 2404 to process received signals properly and to the SIB processing module 2406 so that the SIB processing module may correctly decode a received SIB2.

The apparatus may include additional modules that perform each of the steps of the algorithm in the aforementioned flow charts of FIGS. 17-23. As such, each step in the aforementioned flow charts of FIGS. 17-23 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

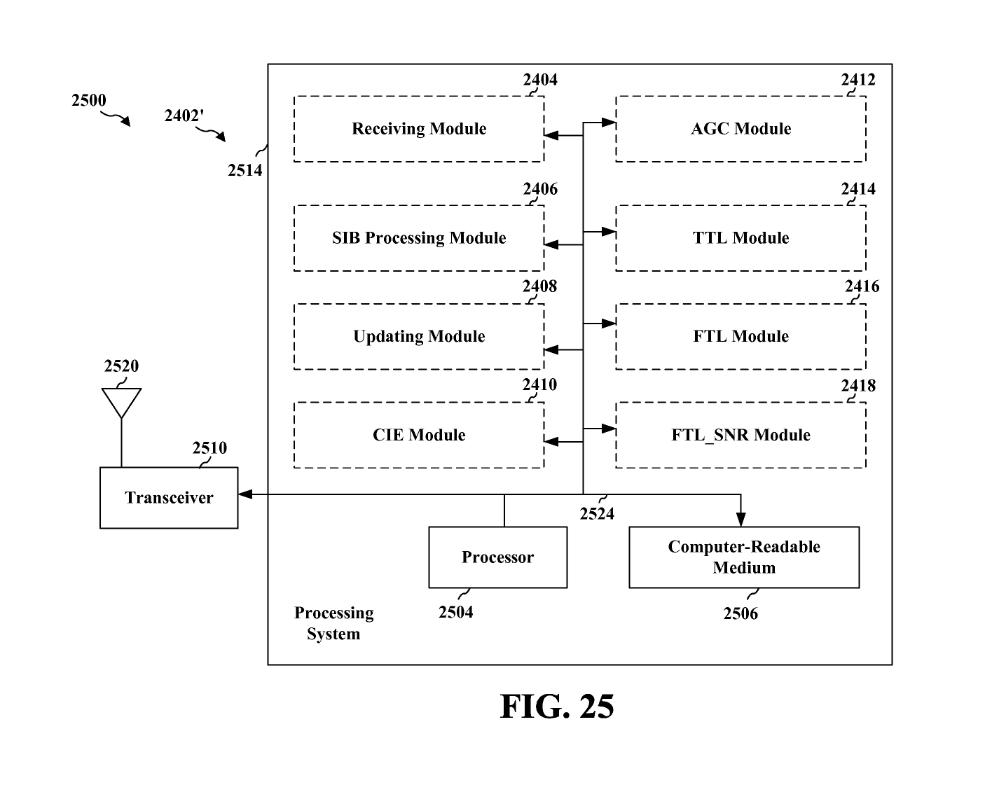

FIG. 25 is a diagram illustrating an example of a hardware implementation for an apparatus 2402′ employing a processing system 2514. The processing system 2514 may be implemented with a bus architecture, represented generally by the bus 2524. The bus 2524 may include any number of interconnecting buses and bridges depending on the specific application of the processing system 2514 and the overall design constraints. The bus 2524 links together various circuits including one or more processors and/or hardware modules, represented by the processor 2504, the modules 2404, 2406, 2408, 2410, 2412, 2414, 2416, 2418, and the computer-readable medium 2506. The bus 2524 may also link various other circuits such as timing sources, peripherals, voltage regulators, and power management circuits, which are well known in the art, and therefore, will not be described any further.

The processing system 2514 may be coupled to a transceiver 2510. The transceiver 2510 is coupled to one or more antennas 2520. The transceiver 2510 provides a means for communicating with various other apparatus over a transmission medium. The processing system 2514 includes a processor 2504 coupled to a computer-readable medium 2506. The processor 2504 is responsible for general processing, including the execution of software stored on the computer-readable medium 2506. The software, when executed by the processor 2504, causes the processing system 2514 to perform the various functions described supra for any particular apparatus. The computer-readable medium 2506 may also be used for storing data that is manipulated by the processor 2504 when executing software. The processing system further includes at least one of the modules 2404, 2406, 2408, 2410, 2412, 2414, 2416, 2418. The modules may be software modules running in the processor 2504, resident/stored in the computer readable medium 2506, one or more hardware modules coupled to the processor 2504, or some combination thereof. The processing system 2514 may be a component of the UE 650 and may include the memory 660 and/or at least one of the TX processor 668, the RX processor 656, and the controller/processor 659.

In one configuration, the apparatus 2402/2402′ for wireless communication includes means for updating a CIE in guaranteed non-MBSFN subframes. In addition, the apparatus includes means for refraining from updating at least one of an AGC, a TTL, an FTL, or an SNR estimation (FTL_SNR) in potential MBSFN subframes before a SIB is decoded to ascertain which subframes of a radio frame are MBSFN subframes and non-MBSFN subframes. The MBSFN subframes include a subset of the potential MBSFN subframes. The non-MBSFN subframes include a remaining subset of the potential MBSFN subframes and the guaranteed non-MBSFN subframes.

In one configuration, the CIE is updated based on an IIR filter, and the apparatus further includes means for refraining from updating the CIE in the potential MBSFN subframes before the SIB is decoded. In one configuration, the CIE is updated based on a FIR filter before the SIB is decoded, and the apparatus further includes means for updating the CIE in the potential MBSFN subframes before the SIB is decoded. The apparatus may further include means for setting coefficients of an IIR filter to provide functionality of the FIR filter before the SIB is decoded. In one configuration, the CIE in guaranteed non-MBSFN subframes is updated based on an IIR filter before the SIB is decoded, and the apparatus further includes means for updating the CIE based on a FIR filter in the potential MBSFN subframes before the SIB is decoded. In one configuration, before the SIB is decoded, the CIE in guaranteed non-MBSFN subframes following a first guaranteed non-MBSFN subframe subsequent to a potential MBSFN subframe is updated based on an IIR filter, and the apparatus further includes means for updating the CIE based on a FIR filter in the potential MBSFN subframes and in the first guaranteed non-MBSFN subframe subsequent to a potential MBSFN subframe.

In one configuration, the CIE is updated based on an IIR filter, and the apparatus further includes means for determining the SNR estimation in each potential MBSFN subframe of the potential MBSFN subframes, means for determining a difference between a previous SNR estimation and the determined SNR estimation in the potential MBSFN subframe, means for refraining from updating the CIE in the potential MBSFN subframe when at least one of the difference is greater than a first threshold or the determined SNR estimation is less than a second threshold, and means for updating the CIE in the potential MBSFN subframe when at least one of the difference is less than the first threshold or the determined SNR estimation is greater than a third threshold. In one configuration, the CIE is updated based on an IIR filter, and the apparatus further includes means for updating the CIE in the potential MBSFN subframes for a set of subframes, means for attempting to decode the SIB in the set of subframes, and means for modifying a method for updating the CIE upon failure to decode the SIB in the set of subframes.

In one configuration, the apparatus includes means for attempting to decode the SIB in all of the subframes of the radio frame to determine the MBSFN subframes and the non-MBSFN subframes. In one configuration, the apparatus includes means for decoding the SIB in one of the subframes of the radio frame to determine the non-MBSFN subframes, and means for updating the CIE and at least one of the AGC, the TTL, the FTL, and the SNR estimation in the determined non-MBSFN subframes. In one configuration, the apparatus includes means for updating the CIE based on a FIR filter separately in each of the potential MBSFN subframes.

The aforementioned means may be one or more of the aforementioned modules of the apparatus 2402 and/or the processing system 2514 of the apparatus 2402′ configured to perform the functions recited by the aforementioned means. As described supra, the processing system 2514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
updating a channel and interference estimation (CIE) in guaranteed non Multi-Media Broadcast over a Single Frequency Network (MBSFN) subframes; and
refraining from updating at least one of an automatic gain control (AGC), a time tracking loop (TTL), a frequency tracking loop (FTL), or a signal to noise ratio (SNR) estimation in potential MBSFN subframes before a system information block (SIB) is decoded to ascertain which subframes of a radio frame are MBSFN subframes and non-MBSFN subframes, the MBSFN subframes comprising a subset of the potential MBSFN subframes, the non-MBSFN subframes comprising a remaining subset of the potential MBSFN subframes and the guaranteed non-MBSFN subframes.

2. The method of claim 1, wherein the CIE is updated based on a finite impulse response (FIR) filter before the SIB is decoded, and the method further comprises updating the CIE in the potential MBSFN subframes before the SIB is decoded.

3. The method of claim 2, wherein the CIE is updated further based on a weighting window, the weighting window being a function of a channel impulse response (CIR) passed through the FIR filter, a signal plus noise energy (SNE) of the CIR, and a signal energy (SE) of the CIR.

4. The method of claim 2, further comprising setting coefficients of an infinite impulse response (IIR) filter to provide functionality of the FIR filter before the SIB is decoded.

5. The method of claim 1, further comprising updating the CIE based on a finite impulse response (FIR) filter separately in each of the potential MBSFN subframes.

6. The method of claim 1, wherein the CIE is updated based on an infinite impulse response (IIR) filter, and the method further comprises refraining from updating the CIE in the potential MBSFN subframes before the SIB is decoded.

7. The method of claim 1, wherein the CIE in guaranteed non-MBSFN subframes is updated based on an infinite impulse response (IIR) filter before the SIB is decoded, and the method further comprises updating the CIE based on a finite impulse response (FIR) filter in the potential MBSFN subframes before the SIB is decoded.

8. The method of claim 1, wherein before the SIB is decoded, the CIE in guaranteed non-MBSFN subframes following a first guaranteed non-MBSFN subframe subsequent to a potential MBSFN subframe is updated based on an infinite impulse response (IIR) filter, and the method further comprises updating the CIE based on a finite impulse response (FIR) filter in the potential MBSFN subframes and in the first guaranteed non-MBSFN subframe subsequent to a potential MBSFN subframe.

9. The method of claim 8, wherein the CIE based on the IIR filter for a guaranteed non-MBSFN subframe following a first guaranteed non-MBSFN subframe subsequent to a potential MBSFN subframe is initialized with the CIE based on the FIR filter from the first guaranteed non-MBSFN subframe subsequent to the potential MBSFN subframe.

10. The method of claim 1, wherein the CIE is updated based on an infinite impulse response (IIR) filter, and the method further comprises:
determining the SNR estimation in each potential MBSFN subframe of the potential MBSFN subframes;
determining a difference between a previous SNR estimation and the determined SNR estimation in the potential MBSFN subframe;
refraining from updating the CIE in the potential MBSFN subframe when at least one of the difference is greater than a first threshold or the determined SNR estimation is less than a second threshold; and
updating the CIE in the potential MBSFN subframe when at least one of the difference is less than the first threshold or the determined SNR estimation is greater than a third threshold.

11. The method of claim 1, wherein the CIE is updated based on an infinite impulse response (IIR) filter, and the method further comprises:
updating the CIE in the potential MBSFN subframes for a set of subframes;
attempting to decode the SIB in the set of subframes; and
modifying a method for updating the CIE upon failure to decode the SIB in the set of subframes.

12. The method of claim 1, further comprising attempting to decode the SIB in all of the subframes of the radio frame to determine the MBSFN subframes and the non-MBSFN subframes.

13. The method of claim 1, further comprising:
decoding the SIB in one of the subframes of the radio frame to determine the non-MBSFN subframes; and
updating the CIE and at least one of the AGC, the TTL, the FTL, and the SNR estimation in the determined non-MBSFN subframes.

14. The method of claim 1, wherein for a frequency division duplexing (FDD) system, the guaranteed non-MBSFN subframes comprise subframes 0, 4, 5, and 9 and the potential MBSFN subframes comprise subframes 1, 2, 3, 6, 7, and 8.

15. The method of claim 1, wherein for a time division duplexing (TDD) system, the guaranteed non-MBSFN subframes comprise subframes 0, 1, 5, and 6 and the potential MBSFN subframes comprise subframes 3, 4, 7, 8, and 9.

16. An apparatus for wireless communication, comprising:
means for updating a channel and interference estimation (CIE) in guaranteed non Multi-Media Broadcast over a Single Frequency Network (MBSFN) subframes; and
means for refraining from updating at least one of an automatic gain control (AGC), a time tracking loop (TTL), a frequency tracking loop (FTL), or a signal to noise ratio (SNR) estimation in potential MBSFN subframes before a system information block (SIB) is decoded to ascertain which subframes of a radio frame are MBSFN subframes and non-MBSFN subframes, the MBSFN subframes comprising a subset of the potential MBSFN subframes, the non-MBSFN subframes comprising a remaining subset of the potential MBSFN subframes and the guaranteed non-MBSFN subframes.

17. The apparatus of claim 16, wherein the CIE is updated based on a finite impulse response (FIR) filter before the SIB is decoded, and the apparatus further comprises means for updating the CIE in the potential MBSFN subframes before the SIB is decoded.

18. The apparatus of claim 17, wherein the CIE is updated further based on a weighting window, the weighting window being a function of a channel impulse response (CIR) passed through the FIR filter, a signal plus noise energy (SNE) of the CIR, and a signal energy (SE) of the CIR.

19. The apparatus of claim 17, further comprising means for setting coefficients of an infinite impulse response (IIR) filter to provide functionality of the FIR filter before the SIB is decoded.

20. The apparatus of claim 16, further comprising means for updating the CIE based on a finite impulse response (FIR) filter separately in each of the potential MBSFN subframes.

21. The apparatus of claim 16, wherein the CIE is updated based on an infinite impulse response (IIR) filter, and the apparatus further comprises means for refraining from updating the CIE in the potential MBSFN subframes before the SIB is decoded.

22. The apparatus of claim 16, wherein the CIE in guaranteed non-MBSFN subframes is updated based on an infinite impulse response (IIR) filter before the SIB is decoded, and the apparatus further comprises means for updating the CIE based on a finite impulse response (FIR) filter in the potential MBSFN subframes before the SIB is decoded.

23. The apparatus of claim 16, wherein before the SIB is decoded, the CIE in guaranteed non-MBSFN subframes following a first guaranteed non-MBSFN subframe subsequent to a potential MBSFN subframe is updated based on an infinite impulse response (IIR) filter, and the apparatus further comprises means for updating the CIE based on a finite impulse response (FIR) filter in the potential MBSFN subframes and in the first guaranteed non-MBSFN subframe subsequent to a potential MBSFN subframe.

24. The apparatus of claim 23, wherein the CIE based on the IIR filter for a guaranteed non-MBSFN subframe following a first guaranteed non-MBSFN subframe subsequent to a potential MBSFN subframe is initialized with the CIE based on the FIR filter from the first guaranteed non-MBSFN subframe subsequent to the potential MBSFN subframe.

25. The apparatus of claim 16, wherein the CIE is updated based on an infinite impulse response (IIR) filter, and the apparatus further comprises:
means for determining the SNR estimation in each potential MBSFN subframe of the potential MBSFN subframes;
means for determining a difference between a previous SNR estimation and the determined SNR estimation in the potential MBSFN subframe;
means for refraining from updating the CIE in the potential MBSFN subframe when at least one of the difference is greater than a first threshold or the determined SNR estimation is less than a second threshold; and
means for updating the CIE in the potential MBSFN subframe when at least one of the difference is less than the first threshold or the determined SNR estimation is greater than a third threshold.

26. The apparatus of claim 16, wherein the CIE is updated based on an infinite impulse response (IIR) filter, and the apparatus further comprises:
means for updating the CIE in the potential MBSFN subframes for a set of subframes;
means for attempting to decode the SIB in the set of subframes; and
means for modifying a method for updating the CIE upon failure to decode the SIB in the set of subframes.

27. The apparatus of claim 16, further comprising means for attempting to decode the SIB in all of the subframes of the radio frame to determine the MBSFN subframes and the non-MBSFN subframes.

28. The apparatus of claim 16, further comprising:
means for decoding the SIB in one of the subframes of the radio frame to determine the non-MBSFN subframes; and
means for updating the CIE and at least one of the AGC, the TTL, the FTL, and the SNR estimation in the determined non-MBSFN subframes.

29. The apparatus of claim 16, wherein for a frequency division duplexing (FDD) system, the guaranteed non-MBSFN subframes comprise subframes 0, 4, 5, and 9 and the potential MBSFN subframes comprise subframes 1, 2, 3, 6, 7, and 8.

30. The apparatus of claim 16, wherein for a time division duplexing (TDD) system, the guaranteed non-MBSFN subframes comprise subframes 0, 1, 5, and 6 and the potential MBSFN subframes comprise subframes 3, 4, 7, 8, and 9.

31. An apparatus for wireless communication, comprising:
a processing system configured to:
update a channel and interference estimation (CIE) in guaranteed non Multi-Media Broadcast over a Single Frequency Network (MBSFN) subframes; and
refrain from updating at least one of an automatic gain control (AGC), a time tracking loop (TTL), a frequency tracking loop (FTL), or a signal to noise ratio (SNR) estimation in potential MBSFN subframes before a system information block (SIB) is decoded to ascertain which subframes of a radio frame are MBSFN subframes and non-MBSFN subframes, the MBSFN subframes comprising a subset of the potential MBSFN subframes, the non-MBSFN subframes comprising a remaining subset of the potential MBSFN subframes and the guaranteed non-MBSFN subframes.

32. The apparatus of claim 31, wherein the CIE is updated based on a finite impulse response (FIR) filter before the SIB is decoded, and the processing system is further configured to update the CIE in the potential MBSFN subframes before the SIB is decoded.

33. The apparatus of claim 32, wherein the CIE is updated further based on a weighting window, the weighting window being a function of a channel impulse response (CIR) passed through the FIR filter, a signal plus noise energy (SNE) of the CIR, and a signal energy (SE) of the CIR.

34. The apparatus of claim 32, wherein the processing system is further configured to set coefficients of an infinite impulse response (IIR) filter to provide functionality of the FIR filter before the SIB is decoded.

35. The apparatus of claim 31, wherein the processing system is further configured to update the CIE based on a finite impulse response (FIR) filter separately in each of the potential MBSFN subframes.

36. The apparatus of claim 31, wherein the CIE is updated based on an infinite impulse response (IIR) filter, and the processing system is further configured to refrain from updating the CIE in the potential MBSFN subframes before the SIB is decoded.

37. The apparatus of claim 31, wherein the CIE in guaranteed non-MBSFN subframes is updated based on an infinite impulse response (IIR) filter before the SIB is decoded, and the processing system is further configured to update the CIE based on a finite impulse response (FIR) filter in the potential MBSFN subframes before the SIB is decoded.

38. The apparatus of claim 31, wherein before the SIB is decoded, the CIE in guaranteed non-MBSFN subframes following a first guaranteed non-MBSFN subframe subsequent to a potential MBSFN subframe is updated based on an infinite impulse response (IIR) filter, and the processing system is further configured to update the CIE based on a finite impulse response (FIR) filter in the potential MBSFN subframes and in the first guaranteed non-MBSFN subframe subsequent to a potential MBSFN subframe.

39. The apparatus of claim 38, wherein the CIE based on the IIR filter for a guaranteed non-MBSFN subframe following a first guaranteed non-MBSFN subframe subsequent to a potential MBSFN subframe is initialized with the CIE based on the FIR filter from the first guaranteed non-MBSFN subframe subsequent to the potential MBSFN subframe.

40. The apparatus of claim 31, wherein the CIE is updated based on an infinite impulse response (IIR) filter, and the processing system is further configured to:
determine the SNR estimation in each potential MBSFN subframe of the potential MBSFN subframes;
determine a difference between a previous SNR estimation and the determined SNR estimation in the potential MBSFN subframe;
refrain from updating the CIE in the potential MBSFN subframe when at least one of the difference is greater than a first threshold or the determined SNR estimation is less than a second threshold; and
update the CIE in the potential MBSFN subframe when at least one of the difference is less than the first threshold or the determined SNR estimation is greater than a third threshold.

41. The apparatus of claim 31, wherein the CIE is updated based on an infinite impulse response (IIR) filter, and the processing system is further configured to:
update the CIE in the potential MBSFN subframes for a set of subframes;
attempt to decode the SIB in the set of subframes; and
modify a method for updating the CIE upon failure to decode the SIB in the set of subframes.

42. The apparatus of claim 31, wherein the processing system is further configured to attempt to decode the SIB in all of the subframes of the radio frame to determine the MBSFN subframes and the non-MBSFN subframes.

43. The apparatus of claim 31, wherein the processing system is further configured to:
decode the SIB in one of the subframes of the radio frame to determine the non-MBSFN subframes; and
update the CIE and at least one of the AGC, the TTL, the FTL, and the SNR estimation in the determined non-MBSFN subframes.

44. The apparatus of claim 31, wherein for a frequency division duplexing (FDD) system, the guaranteed non-MBSFN subframes comprise subframes 0, 4, 5, and 9 and the potential MBSFN subframes comprise subframes 1, 2, 3, 6, 7, and 8.

45. The apparatus of claim 31, wherein for a time division duplexing (TDD) system, the guaranteed non-MBSFN subframes comprise subframes 0, 1, 5, and 6 and the potential MBSFN subframes comprise subframes 3, 4, 7, 8, and 9.

46. A computer program product, comprising:
a computer-readable medium comprising code for:
updating a channel and interference estimation (CIE) in guaranteed non Multi-Media Broadcast over a Single Frequency Network (MBSFN) subframes; and
refraining from updating at least one of an automatic gain control (AGC), a time tracking loop (TTL), a frequency tracking loop (FTL), or a signal to noise ratio (SNR) estimation in potential MBSFN subframes before a system information block (SIB) is decoded to ascertain which subframes of a radio frame are MBSFN subframes and non-MBSFN subframes, the MBSFN subframes comprising a subset of the potential MBSFN subframes, the non-MBSFN subframes comprising a remaining subset of the potential MBSFN subframes and the guaranteed non-MBSFN subframes.
